(19) United States
(12) Patent Application Publication
(10) Pub. No.: US 2026/0045994 A1
(43) Pub. Date: Feb. 12, 2026

(54) CHANNEL STATE INFORMATION REPORTING FOR MULTI-TRANSMISSION AND RECEPTION POINT-BASED BEAM PREDICTION

(71) Applicant: QUALCOMM INCORPORATED, San Diego, CA (US)

(72) Inventors: Qiaoyu Li, Beijing (CN); Mahmoud Taherzadeh Boroujeni, San Diego, CA (US); Hamed Pezeshki, San Diego, CA (US); Tao Luo, San Diego, CA (US)

(21) Appl. No.: 19/101,227

(22) PCT Filed: Sep. 29, 2022
(86) PCT No.: PCT/CN2022/122435

§ 371 Date: Feb. 4, 2025

(51) Int. Cl. H04B 7/06

(52) U.S. Cl. CPC H04B 7/0626; H04B 7/06952

(57) ABSTRACT

Methods, systems, and devices for wireless communications are described. In some aspects, a UE may predict and report signal strength information associated with channel resources of a channel prediction resource (CPR) set based on measured signal strengths of channel resources of a channel measurement resource (CMR) set for each of multiple transmission and reception points (TRPs). For example, each TRP may be associated with a CMR set and a CPR set and the UE may measure signal strengths of channel resources of each CMR set and may use the measured signal strengths to predict signal strengths of channel resources of an associated CPR set. The CE may report predicted signal strengths of the CPR sets in a pair-wise manner via one or more channel resource pairs via a channel state information (CSI) report. In some aspects, the UE may include both predicted and measured signal strengths in the CSI report.

### CROSS REFERENCE

The present Application is a 371 national stage filing of International PCT Application No. PCT/CN2022/122435 by Li et al. entitled “CHANNEL STATE INFORMATION REPORTING FOR MULTI-TRANSMISSION AND RECEPTION POINT-BASED BEAM PREDICTION,” filed Sep. 29, 2022, which is assigned to the assignee hereof, and which is expressly incorporated by reference in its entirety herein.

### INTRODUCTION

The following relates to wireless communications, including channel state information (CSI) reporting for multi-transmission and reception point (TRP)-based beam prediction.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support channel state information (CSI) reporting for multi-transmission and reception point (TRP)-based beam prediction. For example, a user equipment (UE) may predict and report signal strength information associated with channel resources of a channel prediction resource (CPR) set based on measured signal strengths of channel resources of a channel measurement resource (CMR) set for each of multiple TRPs. For example, each TRP may be associated with a CMR set and a CPR set and the UE may measure signal strengths of channel resources of each CMR set and may use the measured signal strengths to predict signal strengths of channel resources of an associated CPR set. The UE may report predicted signal strengths of the CPR sets in a pair-wise manner via one or more channel resource pairs.

A method for wireless communication at a network node is described. The method may include receiving CSI report setting information, where the CSI report setting information is associated with a first channel resource set for channel measurement and a second channel resource set for channel measurement, and where the first channel resource set is associated with a third channel resource set for beam prediction and the second channel resource set is associated with a fourth channel resource set for beam prediction, predicting, based on a set of channel measurements associated with channel resources of the first channel resource set and the second channel resource set, a respective signal strength associated with each respective channel resource of one or more channel resource pairs, where each of the one or more channel resource pairs includes a respective first channel resource from the third channel resource set and a respective second channel resource from the fourth channel resource set, and transmitting a CSI report including information indicative of predicted signal strengths of at least one channel resource pair of the one or more channel resource pairs.

A network node for wireless communication is described. The network node may include a memory and at least one processor coupled to the memory. The at least one processor may be configured to receive CSI report setting information, where the CSI report setting information is associated with a first channel resource set for channel measurement and a second channel resource set for channel measurement, and where the first channel resource set is associated with a third channel resource set for beam prediction and the second channel resource set is associated with a fourth channel resource set for beam prediction, predict, based on a set of channel measurements associated with channel resources of the first channel resource set and the second channel resource set, a respective signal strength associated with each respective channel resource of one or more channel resource pairs, where each of the one or more channel resource pairs includes a respective first channel resource from the third channel resource set and a respective second channel resource from the fourth channel resource set, and transmit a CSI report including information indicative of predicted signal strengths of at least one channel resource pair of the one or more channel resource pairs.

Another network node for wireless communication is described. The network node may include means for receiving CSI report setting information, where the CSI report setting information is associated with a first channel resource set for channel measurement and a second channel resource set for channel measurement, and where the first channel resource set is associated with a third channel resource set for beam prediction and the second channel resource set is associated with a fourth channel resource set for beam prediction, means for predicting, based on a set of channel measurements associated with channel resources of the first channel resource set and the second channel resource set, a respective signal strength associated with each respective channel resource of one or more channel resource pairs, where each of the one or more channel resource pairs includes a respective first channel resource from the third channel resource set and a respective second channel resource from the fourth channel resource set, and means for transmitting a CSI report including information indicative of predicted signal strengths of at least one channel resource pair of the one or more channel resource pairs.

A non-transitory computer-readable medium having code for wireless communication stored thereon at a network node is described. The code for wireless communication stored thereon may, when executed by a network node, cause the network node to receive CSI report setting information, where the CSI report setting information is associated with a first channel resource set for channel measurement and a second channel resource set for channel measurement, and where the first channel resource set is associated with a third channel resource set for beam prediction and the second channel resource set is associated with a fourth channel resource set for beam prediction, predict, based on a set of channel measurements associated with channel resources of the first channel resource set and the second channel resource set, a respective signal strength associated with each respective channel resource of one or more channel resource pairs, where each of the one or more channel resource pairs includes a respective first channel resource from the third channel resource set and a respective second channel resource from the fourth channel resource set, and transmit a CSI report including information indicative of predicted signal strengths of at least one channel resource pair of the one or more channel resource pairs.

In some examples of the method, apparatuses, and non-transitory computer-readable medium described herein, the CSI reporting setting information includes information indicative of the first channel resource set, information indicative of the second channel resource set, information indicative of the third channel resource set, and information indicative of the fourth channel resource set and receiving the CSI report setting information includes receiving a single CSI report setting message including the CSI report setting information.

In some examples of the method, apparatuses, and non-transitory computer-readable medium described herein, receiving the CSI report setting information may include operations, features, means, or instructions for receiving a first CSI report setting message that includes information indicative of the first channel resource set and the second channel resource set and receiving a second CSI report setting message that includes information indicative of the third channel resource set and the fourth channel resource set.

In some examples of the method, apparatuses, and non-transitory computer-readable medium described herein, the CSI report setting information includes information indicative of a first association between the first channel resource set and the third channel resource set and information indicative of a second association between the second channel resource set and the fourth channel resource set.

Some examples of the method, apparatuses, and non-transitory computer-readable medium described herein may further include operations, features, means, or instructions for receiving, via a medium access control (MAC)-control element (CE) configured to activate the first channel resource set and the second channel resource set, an activation of: a first channel resource set pair that includes the first channel resource set and the third channel resource set, and a second channel resource set pair that includes the second channel resource set and the fourth channel resource set.

Some examples of the method, apparatuses, and non-transitory computer-readable medium described herein may further include operations, features, means, or instructions for receiving, via a message associated with an aperiodic trigger state associated with the first channel resource set and the second channel resource set, information indicative of: a first channel resource set pair that includes the first channel resource set and the third channel resource set, and a second channel resource set pair that includes the second channel resource set and the fourth channel resource set.

In some examples of the method, apparatuses, and non-transitory computer-readable medium described herein, the CSI report setting information includes information indicative of a set of multiple channel resource sets for channel measurement, the set of multiple channel resource sets include the first channel resource set and the second channel resource set, and a first subset of the set of multiple channel resource sets may be associated with a corresponding channel resource set for beam prediction and a second subset of the set of multiple channel resource sets may be not associated with a corresponding channel resource set for beam prediction.

Some examples of the method, apparatuses, and non-transitory computer-readable medium described herein may further include operations, features, means, or instructions for receiving, via a MAC-CE that activates the first channel resource set and the second channel resource set or a message associated with an aperiodic trigger state associated with the first channel resource set and the second channel resource set, information indicative of the third channel resource set and the fourth channel resource set, information indicative of a first association between the first channel resource set and the third channel resource set, and information indicative of a second association between the second channel resource set and the fourth channel resource set.

Some examples of the method, apparatuses, and non-transitory computer-readable medium described herein may further include operations, features, means, or instructions for transmitting capability information indicative of an upper limit quantity of CSI reports associated with beam prediction, where a quantity of the at least one channel resource pair of the one or more channel resource pairs included in the CSI report may be associated with the upper limit quantity of CSI reports associated with beam prediction.

In some examples of the method, apparatuses, and non-transitory computer-readable medium described herein, the CSI report includes information indicative of measured signal strengths of one or more second channel resource pairs and each of the one or more second channel resource pairs includes a respective first channel resource from the first channel resource set and a respective second channel resource from the second channel resource set.

In some examples of the method, apparatuses, and non-transitory computer-readable medium described herein, the CSI report includes a first indication of whether a greatest signal strength may be associated with a channel measurement or a channel measurement prediction and includes a second indication of which channel resource set the greatest signal strength may be associated with and the second indication indicates one of the first channel resource set or the second channel resource set if the first indication indicates that the greatest signal strength may be associated with the channel measurement and indicates one of the third channel resource set or the fourth channel resource set if the first indication indicates that the greatest signal strength may be associated with the channel measurement prediction.

In some examples of the method, apparatuses, and non-transitory computer-readable medium described herein, the CSI report includes an absolute indication of the greatest signal strength and includes a set of differential indications, relative to the greatest signal strength, of a remaining set of signal strengths of channel resources of the at least one channel resource pair and the one or more second channel resource pairs and the absolute indication includes a first quantity of bits and each of the set of differential indications includes a second quantity of bits less than the first quantity of bits.

In some examples of the method, apparatuses, and non-transitory computer-readable medium described herein, the CSI report includes a first absolute indication of a first signal strength associated with a channel measurement prediction and includes a second absolute indication of a second signal strength associated with a channel measurement and the first signal strength may be a greatest signal strength relative to a remaining set of predicted signal strengths of channel resources of the at least one channel resource pair and the second signal strength may be a greatest signal strength relative to a remaining set of measured signal strengths of channel resources of the one or more second channel resource pairs.

In some examples of the method, apparatuses, and non-transitory computer-readable medium described herein, the CSI report includes a first set of differential indications, relative to the first signal strength, of the remaining set of predicted signal strengths of channel resources of the at least one channel resource pair and a second set of differential indications, relative to the second signal strength, of the remaining set of measured signal strengths of channel resources of the one or more second channel resource pairs.

In some examples of the method, apparatuses, and non-transitory computer-readable medium described herein, each of the first set of differential indications includes a first quantity of bits and each of the second set of differential indications includes a second quantity of bits different from the first quantity of bits.

Some examples of the method, apparatuses, and non-transitory computer-readable medium described herein may further include operations, features, means, or instructions for receiving first information associated with a first beam shape correspondence between the first channel resource set and the third channel resource set and receiving second information associated with a second beam shape correspondence between the second channel resource set and the fourth channel resource set.

Some examples of the method, apparatuses, and non-transitory computer-readable medium described herein may further include operations, features, means, or instructions for receiving the first information and the second information includes receiving the first information and the second information via the CSI report setting information, a MAC-CE that configured to activate the first channel resource set and the second channel resource set, or a message associated with an aperiodic trigger state associated with the first channel resource set and the second channel resource set.

In some examples of the method, apparatuses, and non-transitory computer-readable medium described herein, the channel resources of the first channel resource set and the second channel resource set may be associated with first reference signal transmissions at a first periodicity, second channel resources of the third channel resource set and the fourth channel resource set may be associated with second reference signal transmissions at a second periodicity, and the second periodicity may be greater than the first periodicity.

In some examples of the method, apparatuses, and non-transitory computer-readable medium described herein, the channel resources of the first channel resource set and the second channel resource set may be associated with first reference signal transmissions at a first periodicity and second channel resources of the third channel resource set and the fourth channel resource set may be associated with an absence of any reference signal transmissions.

In some examples of the method, apparatuses, and non-transitory computer-readable medium described herein, the CSI report includes information indicative of a confidence level associated with one or more channel resources of the at least one channel resource pair associated with beam prediction.

In some examples of the method, apparatuses, and non-transitory computer-readable medium described herein, the first channel resource set and the third channel resource set may be associated with a first TRP and the second channel resource set and the fourth channel resource set may be associated with a second TRP.

Some examples of the method, apparatuses, and non-transitory computer-readable medium described herein may further include operations, features, means, or instructions for receiving the CSI report setting information includes receiving the CSI report setting information over one or more messages and each of the one or more messages includes at least a portion of the CSI report setting information.

A method for wireless communication at a network node is described. The method may include transmitting CSI report setting information, where the CSI report setting information is associated with a first channel resource set for channel measurement and a second channel resource set for channel measurement, and where the first channel resource set is associated with a third channel resource set for beam prediction and the second channel resource set is associated with a fourth channel resource set for beam prediction and receiving a CSI report including information indicative of predicted signal strengths of at least one channel resource pair, where each of the at least one channel resource pair includes a respective first channel resource from the third channel resource set and a respective second channel resource from the fourth channel resource set.

A network node for wireless communication is described. The network node may include a memory and at least one processor coupled to the memory. The at least one processor may be configured to transmit CSI report setting information, where the CSI report setting information is associated with a first channel resource set for channel measurement and a second channel resource set for channel measurement, and where the first channel resource set is associated with a third channel resource set for beam prediction and the second channel resource set is associated with a fourth channel resource set for beam prediction and receive a CSI report including information indicative of predicted signal strengths of at least one channel resource pair, where each of the at least one channel resource pair includes a respective first channel resource from the third channel resource set and a respective second channel resource from the fourth channel resource set.

Another network node for wireless communication is described. The network node may include means for transmitting CSI report setting information, where the CSI report setting information is associated with a first channel resource set for channel measurement and a second channel resource set for channel measurement, and where the first channel resource set is associated with a third channel resource set for beam prediction and the second channel resource set is associated with a fourth channel resource set for beam prediction and means for receiving a CSI report including information indicative of predicted signal strengths of at least one channel resource pair, where each of the at least one channel resource pair includes a respective first channel resource from the third channel resource set and a respective second channel resource from the fourth channel resource set.

A non-transitory computer-readable medium having code for wireless communication stored thereon at a network node is described. The code for wireless communication stored thereon may, when executed by a network node, cause the network node to transmit CSI report setting information, where the CSI report setting information is associated with a first channel resource set for channel measurement and a second channel resource set for channel measurement, and where the first channel resource set is associated with a third channel resource set for beam prediction and the second channel resource set is associated with a fourth channel resource set for beam prediction and receive a CSI report including information indicative of predicted signal strengths of at least one channel resource pair, where each of the at least one channel resource pair includes a respective first channel resource from the third channel resource set and a respective second channel resource from the fourth channel resource set.

In some examples of the method, apparatuses, and non-transitory computer-readable medium described herein, the CSI reporting setting information includes information indicative of the first channel resource set, information indicative of the second channel resource set, information indicative of the third channel resource set, and information indicative of the fourth channel resource set and receiving the CSI report setting information includes receiving a single CSI report setting message including the CSI report setting information.

In some examples of the method, apparatuses, and non-transitory computer-readable medium described herein, transmitting the CSI report setting information may include operations, features, means, or instructions for transmitting a first CSI report setting message that includes information indicative of the first channel resource set and the second channel resource set and transmitting a second CSI report setting message that includes information indicative of the third channel resource set and the fourth channel resource set.

In some examples of the method, apparatuses, and non-transitory computer-readable medium described herein, the CSI report setting information includes information indicative of a first association between the first channel resource set and the third channel resource set and information indicative of a second association between the second channel resource set and the fourth channel resource set.

Some examples of the method, apparatuses, and non-transitory computer-readable medium described herein may further include operations, features, means, or instructions for transmitting, via a MAC-CE configured to activate the first channel resource set and the second channel resource set, an activation of: a first channel resource set pair that includes the first channel resource set and the third channel resource set, and a second channel resource set pair that includes the second channel resource set and the fourth channel resource set.

Some examples of the method, apparatuses, and non-transitory computer-readable medium described herein may further include operations, features, means, or instructions for transmitting, via a message associated with an aperiodic trigger state associated with the first channel resource set and the second channel resource set, information indicative of: a first channel resource set pair that includes the first channel resource set and the third channel resource set, and a second channel resource set pair that includes the second channel resource set and the fourth channel resource set.

In some examples of the method, apparatuses, and non-transitory computer-readable medium described herein, the CSI report setting information includes information indicative of a set of multiple channel resource sets for channel measurement, the set of multiple channel resource sets include the first channel resource set and the second channel resource set, and a first subset of the set of multiple channel resource sets may be associated with a corresponding channel resource set for beam prediction and a second subset of the set of multiple channel resource sets may be not associated with a corresponding channel resource set for beam prediction.

Some examples of the method, apparatuses, and non-transitory computer-readable medium described herein may further include operations, features, means, or instructions for transmitting, via a MAC-CE that activates the first channel resource set and the second channel resource set or a message associated with an aperiodic trigger state associated with the first channel resource set and the second channel resource set, information indicative of the third channel resource set and the fourth channel resource set, information indicative of a first association between the first channel resource set and the third channel resource set, and information indicative of a second association between the second channel resource set and the fourth channel resource set.

Some examples of the method, apparatuses, and non-transitory computer-readable medium described herein may further include operations, features, means, or instructions for receiving capability information indicative of an upper limit quantity of CSI reports associated with beam prediction, where a quantity of the at least one channel resource pair of the one or more channel resource pairs included in the CSI report may be associated with the upper limit quantity of CSI reports associated with beam prediction.

In some examples of the method, apparatuses, and non-transitory computer-readable medium described herein, the CSI report setting information includes information indicative of measured signal strengths of one or more second channel resource pairs and each of the one or more second channel resource pairs includes a respective first channel resource from the first channel resource set and a respective second channel resource from the second channel resource set.

In some examples of the method, apparatuses, and non-transitory computer-readable medium described herein, the CSI report includes a first indication of whether a greatest signal strength may be associated with a channel measurement or a channel measurement prediction and includes a second indication of which channel resource set the greatest signal strength may be associated with and the second indication indicates one of the first channel resource set or the second channel resource set if the first indication indicates that the greatest signal strength may be associated with the channel measurement and indicates one of the third channel resource set or the fourth channel resource set if the first indication indicates that the greatest signal strength may be associated with the channel measurement prediction.

In some examples of the method, apparatuses, and non-transitory computer-readable medium described herein, the CSI report includes an absolute indication of the greatest signal strength and includes a set of differential indications, relative to the greatest signal strength, of a remaining set of signal strengths of channel resources of the at least one channel resource pair and the one or more second channel resource pairs and the absolute indication includes a first quantity of bits and each of the set of differential indications includes a second quantity of bits less than the first quantity of bits.

In some examples of the method, apparatuses, and non-transitory computer-readable medium described herein, the CSI report includes a first absolute indication of a first signal strength associated with a channel measurement prediction and includes a second absolute indication of a second signal strength associated with a channel measurement and the first signal strength may be a greatest signal strength relative to a remaining set of predicted signal strengths of channel resources of the at least one channel resource pair and the second signal strength may be a greatest signal strength relative to a remaining set of measured signal strengths of channel resources of the one or more second channel resource pairs.

In some examples of the method, apparatuses, and non-transitory computer-readable medium described herein, the CSI report includes a first set of differential indications, relative to the first signal strength, of the remaining set of predicted signal strengths of channel resources of the at least one channel resource pair and a second set of differential indications, relative to the second signal strength, of the remaining set of measured signal strengths of channel resources of the one or more second channel resource pairs.

In some examples of the method, apparatuses, and non-transitory computer-readable medium described herein, each of the first set of differential indications includes a first quantity of bits and each of the second set of differential indications includes a second quantity of bits different from the first quantity of bits.

Some examples of the method, apparatuses, and non-transitory computer-readable medium described herein may further include operations, features, means, or instructions for transmitting first information associated with a first beam shape correspondence between the first channel resource set and the third channel resource set and transmitting second information associated with a second beam shape correspondence between the second channel resource set and the fourth channel resource set.

Some examples of the method, apparatuses, and non-transitory computer-readable medium described herein may further include operations, features, means, or instructions for transmitting the first information and the second information includes transmitting the first information and the second information via the CSI report setting information, a MAC-CE configured to activate the first channel resource set and the second channel resource set, or a message associated with an aperiodic trigger state associated with the first channel resource set and the second channel resource set.

In some examples of the method, apparatuses, and non-transitory computer-readable medium described herein, the channel resources of the first channel resource set and the second channel resource set may be associated with first reference signal transmissions at a first periodicity, second channel resources of the third channel resource set and the fourth channel resource set may be associated with second reference signal transmissions at a second periodicity, and the second periodicity may be greater than the first periodicity.

In some examples of the method, apparatuses, and non-transitory computer-readable medium described herein, the channel resources of the first channel resource set and the second channel resource set may be associated with first reference signal transmissions at a first periodicity and second channel resources of the third channel resource set and the fourth channel resource set may be associated with an absence of any reference signal transmissions.

In some examples of the method, apparatuses, and non-transitory computer-readable medium described herein, the CSI report includes information indicative of a confidence level associated with one or more channel resources of the at least one channel resource pair associated with beam prediction.

In some examples of the method, apparatuses, and non-transitory computer-readable medium described herein, the first channel resource set and the third channel resource set may be associated with a first TRP and the second channel resource set and the fourth channel resource set may be associated with a second TRP.

Some examples of the method, apparatuses, and non-transitory computer-readable medium described herein may further include operations, features, means, or instructions for transmitting the CSI report setting information includes transmitting the CSI report setting information over one or more messages and each of the one or more messages includes at least a portion of the CSI report setting information.

### BRIEF DESCRIPTION OF THE DRAWINGS

FIGS. 1 and 2 illustrate examples of wireless communications systems that support channel state information (CSI) reporting for multi-transmission and reception point (TRP)-based beam prediction in accordance with one or more aspects of the present disclosure.

FIGS. 3 and 4 illustrate examples of channel resource set timelines that support CSI reporting for multi-TRP (mTRP)-based beam prediction in accordance with one or more aspects of the present disclosure.

FIG. 5 illustrates an example of a process flow that supports CSI reporting for mTRP-based beam prediction in accordance with one or more aspects of the present disclosure.

FIGS. 6 and 7 show block diagrams of devices that support CSI reporting for mTRP-based beam prediction in accordance with one or more aspects of the present disclosure.

FIG. 8 shows a block diagram of a communications manager that supports CSI reporting for mTRP-based beam prediction in accordance with one or more aspects of the present disclosure.

FIG. 9 shows a diagram of a system including a device that supports CSI reporting for mTRP-based beam prediction in accordance with one or more aspects of the present disclosure.

FIGS. 10 and 11 show block diagrams of devices that support CSI reporting for mTRP-based beam prediction in accordance with one or more aspects of the present disclosure.

FIG. 12 shows a block diagram of a communications manager that supports CSI reporting for mTRP-based beam prediction in accordance with one or more aspects of the present disclosure.

FIG. 13 shows a diagram of a system including a device that supports CSI reporting for mTRP-based beam prediction in accordance with one or more aspects of the present disclosure.

FIGS. 14 and 15 show flowcharts illustrating methods that support CSI reporting for mTRP-based beam prediction in accordance with one or more aspects of the present disclosure.

### DETAILED DESCRIPTION

In some deployment scenarios, such as multi-transmission and reception (TRP) deployment scenarios, a user equipment (UE) may simultaneously receive signaling from multiple TRPs. To support such multi-TRP (mTRP) deployment scenarios, the UE may transmit one or more channel state information (CSI) reports to one or more of the multiple TRPs, where a CSI report may include information indicative of one or more measured signal strengths and information indicative of which one or more channel measurement resources (CMRs) to which the measured signal strengths correspond. In some aspects, for example, a first TRP may transmit reference signals via a first set of CMRs (e.g., CMRs of a first CMR set) while switching between different transmit beams and a second TRP may transmit reference signals via a second set of CMRs (e.g., CMRs of a second CMR set) while switching between different transmit beams. As such, the UE may indicate which CMRs have a relatively greatest signal strength to implicitly indicate which transmit beams the first TRP and the second TRP may use for downlink transmissions to the UE.

In some systems, a UE may use a model, such as an artificial intelligence (AI) or machine learning (ML) model, to predict information associated with a first set of beams based on a set of measurements of a second set of beams. For example, a UE may receive information associated with a set A of beams and a set B of beams and may use signal strength measurements of the set B beams to predict signal strength measurements of the set A beams. In some systems, however, UEs and TRPs may lack a mutually understood mechanism according to which a UE may predict and report signal strengths for beams of multiple TRPs. As such, a UE and any associated TRPs may be unable to use or leverage beam prediction capabilities of the UE in mTRP deployment scenarios, which may preclude the UE and the TRPs from experiencing the lower signaling overhead and reduced power consumption costs associated with using beam prediction at the UE.

In some implementations, a UE and multiple TRPs may support one or more configuration- or signaling-based mechanisms according to which the UE may predict and report signal strength information associated with a set A of beams based on measured signal strengths of a set B of beams for each of the multiple TRPs. For example, the UE may receive information, such as CSI report setting information, from a network entity (e.g., from one of the multiple TRPs, or from another network entity that controls or is associated with the multiple TRPs) and the CSI report setting information may include information indicative of a first CMR set associated with a first TRP and a second CMR set associated with a second TRP. The UE and the multiple TRPs may further support one or more signaling mechanisms, such as radio resource control (RRC) signaling, one or more medium access control (MAC)-control elements (CEs), or downlink control information (DCI), via which the UE and the multiple TRPs may associate or pair one or both of the first CMR set and the second CMR set with a first channel prediction resource (CPR) set and a second CPR set, respectively. As described herein, a CPR set may refer to a set of channel resources that are configured or used for beam prediction instead of, or in addition to, being used for channel measurement. In other words, a CPR set may be associated with a set A of beams and an associated or paired CMR set may be associated with a set B of beams.

Accordingly, in implementations in which the first CMR set and the second CMR set are both configured, activated, or triggered for CSI reporting and are both associated with a respective CPR set, the UE may measure a set of signal strengths of channel resources of the first CMR set and the second CMR set and may use the set of measured signal strengths of the first CMR set and the second CMR set to predict signal strengths of channel resources of the first CPR set and the second CPR set, respectively. In some aspects, the UE may predict signal strengths associated with channel resources of the first CPR set and the second CPR set in a pair-wise manner. For example, the UE may predict signal strengths associated with one or more channel resource pairs, where each channel resource pair includes a respective first channel resource from the first CPR set and a respective second channel resource from the second CPR set. The UE and the TRPs may support one or more quantization schemes according to which the UE may include, in a CSI report, information indicative of a set of predicted signal strengths and information indicative of which CPRs to which the predicted signal strengths correspond.

Particular implementations of the subject matter described in this disclosure can be implemented to realize one or more of the following potential advantages. For example, as a result of supporting the configuration- or signaling-based mechanisms according to which a UE may predict and report signal strengths in mTRP deployments, the UE and the multiple TRPs may achieve lower signaling overhead and reduced measurement-related power consumption costs. In other words, enabling beam prediction for simultaneous mTRP downlink transmissions may reduce the amount of reference signals that each of the multiple TRPs transmit and may reduce the amount of resources via which the UE monitors and measures signal strengths. Further, the UE and the multiple TRPs may support various types of quantization schemes according to which the UE may quantize and report both measured and predicted signal strengths via a CSI report, and such various quantization schemes may be used to enable a configurable balance between lower overhead, greater accuracy, and lower complexity. Moreover, supporting beam prediction procedures in mTRP deployments may facilitate wider of adoption of one or both of AI- or ML-based beam prediction and mTRP system configurations, which may increase connectivity and reduce latency. As such, the UE and the multiple TRPs may employ the described techniques in various scenarios, including beam management procedures, and may experience higher data rates, greater capacity, and higher spectral efficiency.

Aspects of the disclosure are initially described in the context of wireless communications systems. Aspects of the disclosure are additionally illustrated by and described with reference to channel resource set timelines and a process flow. Aspects of the disclosure are further illustrated by and described with reference to apparatus diagrams, system diagrams, and flowcharts that relate to CSI reporting for mTRP-based beam prediction.

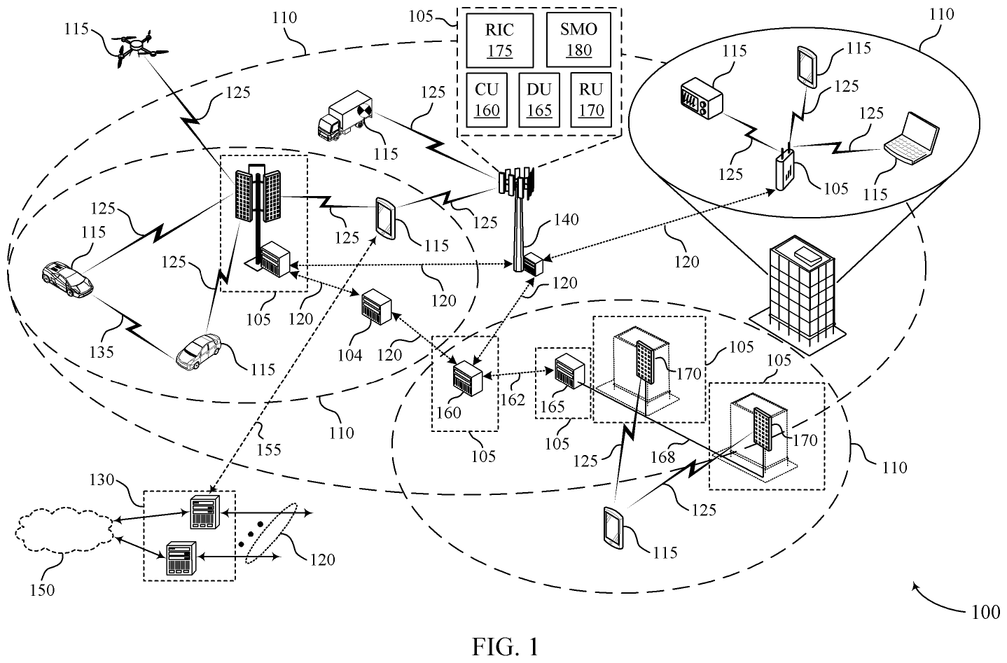

FIG. 1 illustrates an example of a wireless communications system 100 that supports CSI reporting for mTRP-based beam prediction in accordance with one or more aspects of the present disclosure. The wireless communications system 100 may include one or more network entities 105, one or more UEs 115, and a core network 130. In some implementations, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some implementations, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

In some implementations, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some implementations, network entities 105 may communicate with one another via a backhaul communication link 120 (e.g., in accordance with an X2, Xn, or other interface protocol) either directly (e.g., directly between network entities 105) or indirectly (e.g., via a core network 130). In some implementations, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some implementations, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some implementations, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a TRP. One or more components of the network entities 105 in a disaggregated RAN architecture may be co-located, or one or more components of the network entities 105 may be located in distributed locations (e.g., separate physical locations). In some implementations, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some implementations, the CU 160 may host upper protocol layer (e.g., layer 3 (L3), layer 2 (L2)) functionality and signaling (e.g., RRC, service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, MAC layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some implementations, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some implementations, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support CSI reporting for mTRP-based beam prediction as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some implementations, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting.” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some implementations, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., Nr) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some implementations, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some implementations, a network entity 105 (e.g., a base station 140, an RU 170) may be movable and therefore provide communication coverage for a moving coverage area 110. In some implementations, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some implementations, a UE 115 may be configured to support communicating directly with other UEs 115 via a device-to-device (D2D) communication link 135 (e.g., in accordance with a peer-to-peer (P2P), D2D, or sidelink protocol). In some implementations, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some implementations, one or more UEs 115 of such a group may be outside the coverage area 110 of a network entity 105 or may be otherwise unable to or not configured to receive transmissions from a network entity 105. In some implementations, groups of the UEs 115 communicating via D2D communications may support a one-to-many (1:M) system in which each UE 115 transmits to each of the other UEs 115 in the group. In some implementations, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHZ, also known as the centimeter band, or using an extremely high frequency (EHF) region of the spectrum (e.g., from 30 GHz to 300 GHz), also known as the millimeter band. In some implementations, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some implementations, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some implementations, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some implementations, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some implementations, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some implementations, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some implementations, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some aspects, the wireless communications system 100 may support one or more beam management techniques. For example, a UE 115 may be in an RRC idle state (e.g., RRC_IDLE) or an RRC inactive state (e.g., RRC_INACTIVE) and may transmit or receive one or more tracking reference signals (TRSs) prior to initial access. As part of initial access, one or more devices (e.g., one or both of a UE 115 and a network entity 105) may perform synchronization signal block (SSB) beam sweeping, which may be associated with wide beam sweeping. In some aspects, initial access may involve a contention based random access (CBRA) procedure associated with transmission or reception of random access channel (RACH) occasions (ROs) or preambles or transmission or reception of SSBs or a contention free random access (CFRA) procedure.

Upon establishment of a beam pair between two devices (e.g., between a UE 115 and a network entity 105), each device may perform beam management in an RRC connected state (e.g., RRC_CONNECTED). In some aspects, such beam management may include transmission or reception of one or more SSBs, one or more CSI reference signals (CSI-RSs), or one or more sounding reference signals (SRSs), Layer 1 (L1) reference signal receive power (RSRP) reporting, and transmission configuration indicator (TCI) state configuration or indication. In some aspects, beam management (e.g., SSB or CSI-RS associated beam management) may be associated with a set of processes P1, P2, and P3 that are designed for beam management while a device is in a connected state. P1 may be associated with beam selection (e.g., a network entity 105 may sweep a beam and a UE 115 may select one of the beams and report the selected beam to the network entity 105), P2 may be associated with beam refinement for the transmitter (e.g., a network entity 105 may refine a beam via sweeping a narrower beam across a narrower range and a UE 115 may select one of the narrower beams and report the selected narrower beam to the network entity 105), and P3 may be associated with beam refinement for the receiver (e.g., a network entity 105 may fix a beam and a UE 115 may refine its receive beam). In some aspects, beam management (e.g., SRS associated beam management) may be associated with a set of different uplink beam management procedures U1, U2, and U3, where each beam management procedure may be associated with a beam sweep.

Additionally, or alternatively, beam management may include L1 signal-to-interference-plus-noise ratio (SINR) reporting and overhead and latency reduction. In some aspects, overhead and latency reduction may be associated with or otherwise involve one or more component carrier (CC) group beam updates and lower latency uplink beam updates. Further, in some aspects, beam management may involve beam measurement or reporting, or both with association to unified TCI states and L1 or Layer 2 (L2) centric mobility. For example, beam management procedures may include dynamic TCI state updates, uplink multi-panel selection, maximum permissible exposure (MPE) mitigation, or other techniques that facilitate further beam management latency reduction. Further, some beam management procedures may include procedures associated high speed train (HST) deployments, single frequency network (SFN) deployments, or multi-TRP deployments, or any combination thereof.

In some aspects, a device may measure, identify, or otherwise experience a beam failure detection (BFD) based on measurements associated with beam management and may perform one or more beam failure recovery procedures. BFD and a beam failure recovery (BFR) may be performed for a primary cell (PCell), a primary secondary cell (PSCell), or a secondary cell (SCell). Further, BFD and BFR may involve transmission or reception of one or more BFD reference signals (BFD-RSs), a physical downlink control channel (PDCCH) block error rate (BLER) measurement, a link recovery request via a scheduling request (SR), or a MAC-CE-based BFR for SCell, or any combination thereof. In some cases, such as in cases in which a device is unable to recover a failed beam pair link, the device may declare a radio link failure (RLF) and attempt to re-establish a connection via one or more initial establishment procedures.

Various devices of the wireless communications system 100 may support one or more AI or ML models associated with air-interface predictions (e.g., predictions associated with wireless communication). In some deployments, for example, a device may leverage or use an AI or ML model for CSI feedback enhancement (e.g., for overhead reduction, greater accuracy, and more accurate prediction), beam management (e.g., beam prediction in time or spatial domain for overhead and latency reduction as well as for greater beam selection accuracy), or positioning accuracy enhancements for different scenarios (e.g., scenarios associated with heavy non-line-of-sight (NLOS) conditions).

In some cases, the device may leverage or use an AI or ML model for a specific use case such that the AI or ML model approach is diverse enough to support various constraints on collaboration levels between a UE 115 and a network entity 105. Further, various devices may support one or both of an AI or ML model or description to identify common and specific characteristics for framework investigations or decisions. For example, devices may support a model and description to characterize lifecycle management of an AI or ML model, such as aspects relating to model training, model deployment, model inference, model monitoring, or model updating.

In some deployments, a UE 115 or a network entity 105 may use AI or ML based predictive beam management (e.g., for Uu beam management). For example, other beam management techniques may involve an identification of beam qualities or failures via measurements, which may be associated with greater power or overhead to achieve suitable performance. Further, measurement-based beam management may be associated with a limited accuracy due to constraints on power or overhead and latency and throughput may be adversely impacted by beam resumption efforts. Predictive beam management, on the other hand, may be associated with power or overhead reduction, greater accuracy, lower latency, or higher throughput. For example, a predictive beam management procedure may enable a device to predict non-measured beam qualities (which may be associated with lower power consumption, lower overhead, or greater beam selection accuracy) and to predict future beam blockages or failures (which may be associated with lower latency and greater throughput). Such predictive beam management may involve predictions in a spatial domain, a time domain, a frequency domain, or any combination thereof.

Some devices may specifically employ AI or ML to compensate or address that beam prediction may be a highly non-linear problem in some deployments. For example, predicting a future transmit beam quality may depend on a speed or trajectory of a UE 115, one or more receive beams that are to be used, or interference, among other examples, which may be difficult to model via some statistical signaling processing methods (e.g., non-AI or ML based statistical processing methods). In some deployments, there may be a tradeoff between performance and UE power consumption based on whether beam prediction is performed at a UE 115 or a network entity 105. For example, to predict future downlink transmit beam qualities, a UE 115 may have more observations (e.g., via measurements) than a network entity 105 (e.g., via UE feedback messages), thus beam prediction at a UE 115 may outperform beam prediction at a network entity 105 (at the cost of consuming more UE power for the prediction or inference processing tasks). Further, model training may be performed at either a UE 115 or a network entity 105 and a decision between training location may be associated with efforts on data collection as compared to efforts on UE computation. For example, if training is performed by a network entity 105, data may be collected via an air interface or via application layer approaches. If training is performed by a UE 115, the UE 115 may perform additional UE computation or buffering tasks for the model training and associated data storage.

AI or ML-based spatial domain or time domain beam prediction or selection (e.g., for downlink) may relate to one or more of various procedures. For example, AI or ML-based spatial domain or time domain beam prediction or selection may be used for initial access, secondary cell group (SCG) setup, serving beam refinement, link quality and interference adaptation (e.g., one or more parameters, such as a channel quality indicator (CQI) or a precoding matrix indicator (PMI)), beam failure or blockage prediction, or RLF prediction. In some aspects, specific one or more selection or prediction schemes may be used for each of such various procedures. For example, codebook-based spatial domain selection may be used for initial access, SCG setup, serving beam refinement, or link quality and interference adaptation. Non-codebook-based spatial domain prediction may be used for serving beam refinement and link quality and interference adaptation. Additionally, or alternatively, joint spatial domain and time domain beam prediction may be used for serving beam refinement, link quality and interference adaptation, beam failure or blockage prediction, or RLF failure prediction.

Codebook-based spatial domain selection may be associated with an input of a first set of beams (e.g., measurements of a first set of beams) and a predicted output (e.g., an output of an AI or ML model) of a second set of beams (e.g., a predicted set of beams). For interference at a network entity 105, the input may be associated with or include UE feedbacks and side information (e.g., history or location information. For inference at a UE 115, the input may be associated with or include UE measurements and side information (e.g., location information). A UE 115 may report or measure such measurement information using spatial domain or time domain compressive beam measurements. Codebook-based spatial domain selection may be associated with fewer beam measurements, which may lead to power reduction at a measuring device (e.g., a UE 115).

Non-codebook-based spatial domain prediction may be associated with an input of a set of channels or beams (e.g., measurements associated with a set of channels or beams) and an output of a point direction, an angle of departure (AoD), or an angle of arrival (AoA). For inference at a network entity 105, the input may be associated with or include UE feedbacks and side information (e.g., history or location information). For inference at a UE 115, the input may be associated with or include UE measurements and side information (e.g., location information). Such reporting or measuring of such measurement information at a UE 115 may be facilitated via raw channel extraction. Non-codebook-based spatial domain prediction may be associated with greater beam management accuracy without excessive beam sweepings.

From spatial domain to spatial domain plus time domain, joint spatial domain and time domain beam prediction may be associated with a time series input and outputs associated with both codebook-based spatial domain and time domain beam prediction and non-codebook-based spatial domain and time domain point direction, AoD, or AoA prediction. The time series input may include a UE report or measurement at a first time or measurement occasion (e.g., a measurement occasion #0) through a UE report or measurement at an N^{th} time or measurement occasion (e.g., a measurement occasion #N). In accordance with the joint spatial domain and time domain beam prediction, the time series input may be input to a first AI or ML model to obtain a first output of codebook-based spatial domain and time domain beam prediction and may be input to second AI or ML model to obtain a second output of non-codebook-based spatial domain and time domain point direction, AoD, or AoA prediction.

Prediction performance or costs may depend on whether prediction is performed by a UE 115 or a network entity 105. If prediction is performed at a network entity 105, the network entity 105 may use relatively more powerful computational capabilities (e.g., as compared to a UE 115), access to historical and location-wise LI report distributions, access to feedbacks or locations of other UEs 115, awareness of transmit beam shapes and pointing directions to assist in beam prediction. In some deployments, prediction performance at the network entity 105 may be balanced with other factors, such as that only a strongest one or more beams may be reported by a UE 115, a difficulty to know receive beams used to derive the L1 or CSI feedbacks, (all) UE feedbacks being quantized (and could potentially be missed), and that it may be difficult to know an orientation or rotation status of a UE 115. If beam prediction is performed at a UE 115, the UE 115 may use access to instantaneous and filtered measurements of a set of (e.g., all) beams, access to the receive beams used to derive the measurements, (all) measurements being raw or non-quantized, and an awareness (at least in part) of or an ability to predict its own orientation and rotation to assist in beam prediction. In some deployments, prediction performance at the UE 115 may be balanced with other factors, such as that the UE 115 may have relatively limited computational capabilities, relatively limited knowledge on historical distribution of L1 reports in the cell, a difficulty to access L1 or CSI feedbacks of other UEs 115, or a relatively limited indication or perception on transmit beam shapes or pointing directions.

In some deployments, devices of the wireless communications system 100 may support, for AI or ML-based beam management, one or more beam management cases for characterization and baseline performance evaluations. A first beam management case, or BM-Case1, may be associated with spatial domain downlink beam prediction for a set A of beams based on measurement results of a set B of beams. A second beam management case, or BM-Case2, may be associated with temporal downlink beam prediction for a set A of beams based on historic (e.g., previous) measurement results of a set B of beams.

Beams of the set A and the set B may be in a same frequency range or in different frequency ranges. In some aspects, set B may be a subset of set A, where the number of beams in set A and in set B may vary. In some other aspects, set A and set B may be different. For example, set A may include a set of relatively narrower beams and set B may include a set of relatively wider beams. In such aspects, where the number of beams in set A and in set B may vary and there may be a defined quasi-colocation (QCL) relation between beams in set A and beams in set B. Further, various types or implementations of codebook constructions of set A and set B may be used without exceeding the scope of the present disclosure. In the context of such a set A of beams and a set B of beams, set A may be for downlink beam prediction and set B may be for downlink beam measurement.

A UE 115 may receive control signaling from a network entity 105 that indicates, configures, activates, or triggers a CSI report from the UE 115. For example, a UE 115 may be configured to transmit one or more synchronization signal (SS)/physical broadcast channel (PBCH) resource indicator (SSBRI) or a CSI-RS resource indicator (CRI) and L1-RSRP or L1-SINR reports via one or more CSI reports. In some deployments, a UE 115 may receive (e.g., be configured with) a ReportQuantity=ssb-Index-RSRP, ssb-Index-SINR, cri-RSRP, or cri-SINR for joint SSBRI/CRI and L1-RSRP/L1-SINR beam reporting. The UE 115 may report (e.g., transmit) a nrofReportedRS parameter (which may be RRC configured, and may be up to 2 or 4 depending on UE capability), which may be different for SSBRI or CRI for each CSI-ReportConfig.

For L1-RSRP reporting, for a strongest SSBRI/CRI, 7 bits may be used to report RSRP in a range of [−140, −44] dBm with a 1 dBm step size. For remaining SSBRI(s)/CRI(s), 4 bits may be used to report a differential RSRP in a range of [0, −30] dB with a 2 dB step size and a reference to the L1-RSRP of the strongest SSBRI/CRI (e.g., the greatest RSRP reported, in absolute or full terms, via the 7 bits). For the L1-RSRP of the strongest SSBRI/CRI, there may be one or more invalid codepoints considering that 27=128 but 140-44+1=97. In some systems, a mapping between the reported 7-bit and 4-bit codepoints and the actually measured RSRP values may be defined by a specification, such as a network specification.

Similarly, for L1-SINR reporting, for a strongest SSBRI/CRI, 7 bits may be used to report SINR in a range of [−23, 40] dB with a 0.5 dB step size. For remaining SSBRI(s)/CRI(s), 4 bits may be used to report a differential SINR in a range of [0, −15] dB with a 1 dB step size and a reference to the L1-SINR of the strongest SSBRI/CRI (e.g., the greatest SINR reported, in absolute or full terms, via the 7 bits). For the strongest and the remaining SSBRI(s)/CRI(s), there may be no invalid codepoints, but SINR_0 may stand for an SINR of less than or equal to −23 dB for the strongest SSBRI/CRI, while DIFFSINR_15 may stand for a delta SINR of less than or equal to −15 dB. In some systems, a mapping between the reported 7-bit and 4-bit codepoints and the actually measured SINR values may be defined by a specification, such as a network specification.

In some deployments, various devices in the wireless communications system 100 may support CSI reporting in mTRP deployments. For example, when associated with an aperiodic resource setting, such devices may extend an RRC parameter CSI-AssociatedReportConfigInfo to be configured with two CMR sets, where each may be configured or associated with respective QCL information. When associated with a periodic or semi-persistent resource setting, the resource setting may include two CMR sets. In some deployments, devices may support less than or equal to 2 beams per group M for some beam reporting options.

In mTRP deployments, a UE 115 may include differential L1-RSRP reporting across all beam groups in a CSI report. In such deployments, the UE 115 may include, in the CSI report, a 1-bit indicator of the CMR set associated with the largest RSRP value in all groups (where the “best,” or strongest, beam may be assumed to be in a first group). The 1 bit indicating the CMR set with the higher RSRP value may be set to 0 to indicate a first SSBRI/CRI from a first CMR set and may be set to 1 to indicate a first SSBRI/CRI from a second CMR set. Further, uplink control information (UCI) payload partitioning may be set to 7/4 bits for first/second SSBRI/CRI in the first beam group and 4 bits for beams in other groups. Additional details of a UCI example in which a number of groups N is equal to 2 and a number of beams per group M is equal to 2 are illustrated by Table 1, shown below, where the CMR associated with the strongest or greatest RSRP measurement is an example CMR #1, which may be indicated by the first beam group/pair.

TABLE 1
Example CSI Report in UCI

| 1-bit indicator of | | | | Absolute | |
|---|---|---|---|---|---|
| the CMR set | CMR IDs Across 2 CMR Sets | | | L1-RSRP | |
| associated with the | | In CMR set | In CMR set | for the | Differential L1- |
| strongest L1-RSRP | | #1 (2 bits per | #2 (3 bits per | strongest | RSRPs for |
| across all CMRs | | CMR-ID) | CMR-ID) | beam | other beams |
| “0” → CMR set #1 | Beam | CMR #1 | CMR #5 | 7 bits for | 4 bits for each |
| includes the | Pair #1 | | | CMR #1 | of the CMRs |
| strongest beam | Beam | CMR #2 | CMR #6 | | among CMR #2, |
| among all CMRs | Pair #2 | | | | #5, and #6 |

In mTRP scenarios, a UE 115 may lack a configured or known mechanism according to which the UE 115 may report predicted beam pairs. For example, in scenarios in which each TRP includes or is associated with a respective set A beams and set B beams, or one of multiple TRPs includes or is associated with a set A of beams and a set B of beams, some L1 reporting signaling mechanisms may be unable to support predicted beam pair reporting. For example, in some mTRP L1 report configurations, periodic or semi-persistent CSI report settings may be restricted to including two CMR sets while an aperiodic CSI report setting may include multiple CMR sets and an aperiodic CSI triggering state configuration may select two CMR sets for an mTRP L1 report, but all of such CSI report settings may lack an ability to include or indicate channel resources associated with beam prediction. As such, a UE 115 may be unable to provide beam prediction information in some deployment scenarios, such as mTRP deployment scenarios, which may limit implementation options for beam prediction.

Accordingly, in some implementations, a UE 115 and a network entity 105 (e.g., one or more TRPs) may support set A and set B beam associations for mTRP deployments and one or more corresponding network signaling and UE reporting mechanisms. In some aspects, such signaling and reporting mechanisms may support beam prediction at the UE 115 and support an mTRP L1 report that is capable of indicating predicted beam pairs for one or multiple TRPs. For example, the UE 115 and the multiple TRPs may support CSI report settings that support information indicative of set A and set B beam details together with their associations and L1 CSI reports that may be used to carry or indicate L1-RSRP/L1-SINR values of a set of one or more predicted beams associated with the set B beams that the network (e.g., the network entity 105) configures in the CSI report setting. In some implementations, the UE 115 and the network entity 105 (e.g., one or more TRPs) may support dynamically changing or updating set A beams and set B beams and may support various MAC-CE- or DCI-related signaling aspects for CSI reports, while also supporting signaling mechanisms to support beam prediction via CSI reporting for mTRP scenarios associated with (e.g., involving) more than two TRPs.

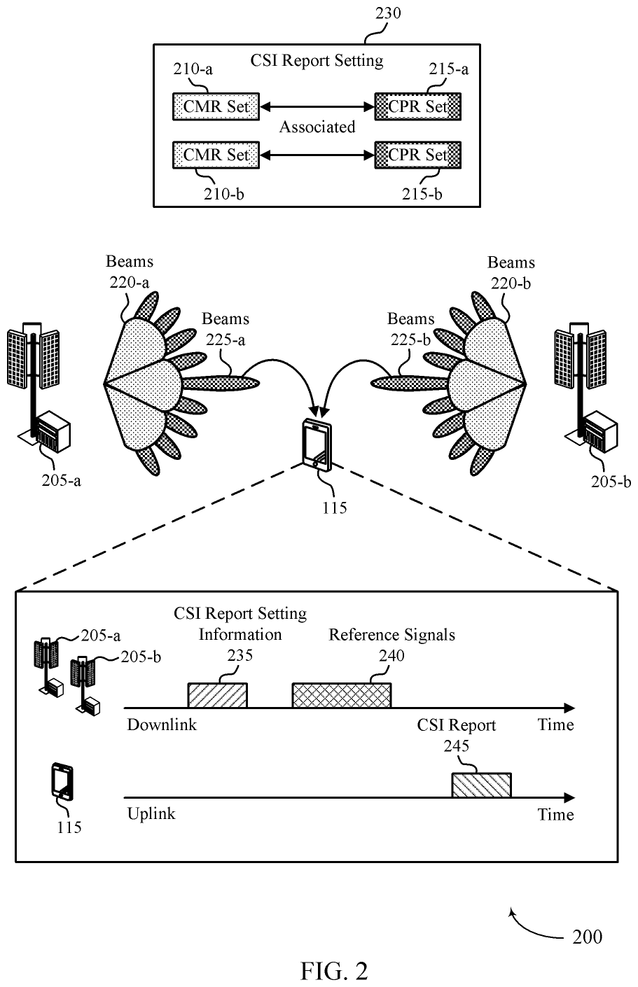

FIG. 2 illustrates an example of a wireless communications system 200 that supports CSI reporting for mTRP-based beam prediction in accordance with one or more aspects of the present disclosure. The wireless communications system 200 may implement or be implemented to realize aspects of the wireless communications system 100. For example, the wireless communications system 200 illustrates communication between a UE 115, a TRP 205-a, and a TRP 205-b, which may be examples of corresponding devices described herein, including with reference to FIG. 1. In some implementations, the UE 115, the TRP 205-a, and the TRP 205-b may support networking signaling and UE reporting mechanisms to facilitate or support indications of predicted signal strengths associated with channel resources of one or more CPR sets 215 based on measurements of channel resources of one or more CMR sets 210. In other words, the UE 115, the TRP 205-a, and the TRP 205-b may support one or more configuration- or signaling-based mechanisms according to which the UE 115, the TRP 205-a, and the TRP 205-b may support set A and set B beam association and group-based L1 report (e.g., a group-based L1-RSRP/L1-SINR report) for mTRP beam prediction. As described herein, any one or more of the UE 115, the TRP 205-a, and the TRP 205-b may be referred to or understood as a network node.

As described herein, a set A of beams may be predicted and a set B of beams may actually be measured. For example, the TRP 205-a and the TRP 205-b may transmit one or more reference signals using each beam of a set B of beams via channel resources of a CMR set 210-a and a CMR set 210-b, respectively, where a set B of beams may include a set of beams 220-a from the TRP 205-a and a set of beams 220-b from the TRP 205-b. Further, the UE 115 may predict measurement information (e.g., a signal strength, such as an L1-RSRP or L1-SINR measurement) for each of at least a subset of set A beams associated with each of the TRP 205-a and the TRP 205-b. Set A beams may include a set of beams 225-a from the TRP 205-a and a set of beams 225-b from the TRP 205-b, which may be associated with channel resources of a CPR set 215-a and a CPR set 215-b, respectively. In other words, the set of beams 220-a may be associated with the CMR set 210-a, the set of beams 220-b may be associated with the CMR set 210-b, the set of beams 225-a may be associated with the CPR set 215-a, and the set of beams 225-b may be associated with the CPR set 215-b. In some aspects, a set of beams 220 (e.g., the set of beams 220-a and the set of beams 220-b) may be relatively wider beams and the set of beams 225 (e.g., the set of beams 225-a and the set of beams 225-b) may be relatively narrower beams.

A CMR set 210 (e.g., either or both of the CMR set 210-a and the CMR set 210-b) may be referred to herein as a channel resource set for channel measurement and a CPR set 215 (e.g., either or both of the CPR set 215-a and the CPR set 215-b) may be referred to herein as a channel resource set for beam prediction. The CMR set 210-a and the CPR set 215-a may be associated with each other, which may refer to how the UE 115 uses measurements of one or more channel resources of the CMR set 210-a to predict measurements of one or more channel resources of the CPR set 215-a. Similarly, the CMR set 210-b and the CPR set 215-b may be associated with each other, which may refer to how the UE 115 may use measurements of one or more channel resources of the CMR set 210-b to predict measurements of one or more channel resources of the CPR set 215-b. Further, although described herein as a CPR set 215, channel resources of a CPR set 215 may additionally, or alternatively, be part of a CMR set, where such a CMR set may be configured, indicated, or defined as being for or associated with channel or beam prediction functions.

The UE 115 may receive configuration information associated with the CMR set 210-a and the CMR set 210-b, and potentially also information indicative of the associations between CMR sets 210 and CPR sets 215, via a CSI report setting 230. The UE 115 may receive signaling associated with the CSI reporting setting 230 via CSI report setting information 235, which may be associated with (e.g., include information indicative of or otherwise enable future indications of) two or more CMR sets 210 (e.g., the CMR set 210-a and the CMR set 210-b) for channel measurement and two or more CPR sets 215 (e.g., the CPR set 215-a and the CPR set 215-b). In accordance with the CSI report setting information 235, the CMR set 210-a may include N1 CMRs (e.g., SSBs or non-zero power (NZP)-CSI-RSs) and the CMR set 210-b may include N2 CMRs, where N1 and N2 may be the same or different. The CPR set 215-a may include M1 CPRs and the CPR set 215-b may include M2 CPRs, where M1 and M2 may be the same or different.

In some implementations, the signaling associated with the CSI report setting 230 (e.g., the CSI report setting information 235) may depend on whether the CSI report setting 230 is associated with periodic, semi-persistent, or aperiodic CSI reports 245. For a CSI report setting 230 associated with any of periodic, semi-persistent, or aperiodic CSI reports 245, the CMR set 210-a, the CMR set 210-b, the CPR set 215-a, and the CPR set 215-b may be directly configured by the CSI report setting 230 (e.g., all channel resource sets may be configured by the CSI report setting 230, which may be understood as a single CSI report setting message and equivalently referred to as a CSI resource setting). Alternatively, the CMR set 210-a and the CMR set 210-b may be configured by a first CSI report setting message and the CPR set 215-a and the CPR set 215-b may be configured by a second CSI report setting message, which may be referred to as a CSI prediction setting. Such a second CSI report setting message may configure or indicate channel resources or channel resource sets that are to be used for beam or channel prediction (e.g., as opposed to for beam or channel measurement).

For a CSI report setting 230 associated with semi-persistent CSI reports 245, the CSI report setting 230 may configure multiple (e.g., greater than two) {CMR set, CPR set} pairs and a MAC-CE activating the semi-persistent CSI report 245 may further activate two pairs of {CMR set, CPR set} to be used for channel measurement and beam prediction. As described herein, a {CMR set, CPR set} pair may refer to a CMR set 210 and a CPR set 215 that are paired or associated with each other. For a CSI report setting 230 associated with aperiodic CSI reports 245, the CSI report setting 230 may configure multiple (e.g., greater than two) {CMR, CPR set} pairs and an aperiodic CSI triggering state configuration associated with the CSI report setting 230 (e.g., a message, such as a DCI message, that triggers an aperiodic CSI report 245) may further select two pairs of {CMR set, CPR set} to be used for channel measurement and beam prediction.

In some implementations, the UE 115, the TRP 205-a, and the TRP 205-b may support signaling associated with the CSI report setting 230 that facilitates communication of a UE capability on a simultaneously configured or activated number of CSI reports 245 associated with beam prediction (e.g., CSI reports 245 that carry predicted signal strengths associated with one or more channel resources of one or more CPR sets 215). In other words, the UE 115 may report a capability of the UE 115 on a maximum (e.g., upper limit) number of CSI reports 245 with such types of configurations or indications (e.g., configurations or indications relating to one or more CPR sets 215 in addition to one or more CMR sets 210) that may be simultaneously configured or activated at the UE 115. Configured CSI reports 245 may refer to a number of CSI report settings that are configured via RRC signaling and activated CSI reports 245 may refer to how many are RRC configured for periodic CSI reporting, how many are MAC-CE activated for semi-persistent CSI reporting, or how many are DCI triggered for aperiodic CSI reporting. In some implementations, the UE 115 may perform such capability reporting by separately reporting capabilities associated with periodic, semi-persistent, and aperiodic CSI reports 245, as each of periodic, semi-persistent, and aperiodic CSI reports 245 may be associated with different types of indication schemes.

In some aspects, an additional information element (IE) may be included in the CSI report setting 230. Such an additional IE may be referred as beamPredictionmTRP, and may indicate that the CSI report setting 230 is a type of CSI report setting 230 that is dedicated for mTRP beam prediction use cases. In such aspects, the UE capability indication reported by the UE 115 may indicate a number (e.g., a maximum or upper limit number) of CSI reports 245 including such additional IEs. Additionally, or alternatively, a quantity of CMRs/CPRs together with corresponding measured or predicted signal strengths (e.g., L1-RSRPs/L1-SINRs) that are addressed in an L1 report (e.g., a CSI report 245) may be configured or indicated by the CSI report setting 230. In other words, the TRP 205-a or the TRP 205-b may indicate, via the CSI report setting information 235, how many CMRs and CPRs (and corresponding measured signal strengths or predicted signal strengths, respectively) are to be included in a CSI report 245).

In some implementations, the UE 115, the TRP 205-a, and the TRP 205-b may exchange signaling that supports or indicates beam associations between CMR sets 210 and CPR sets 215. For example, the UE 115 may receive signaling from a network entity 105 (e.g., one of the TRP 205-a or the TRP 205-b or a separate entity associated with one or both of the TRP 205-a and the TRP 205-b) indicating beam shape correspondence between CMRs and CPRs in each paired {CMR set, CPR set}. In other words, the UE 115, the TRP 205-a, and the TRP 205-b may associate set A beams (which may be associated with a CPR set 215) and set B beams (which may be associated with a CMR set 210) to assist the UE 115 with predicting beams in a spatial domain or a time domain. The beam shape correspondence information may include information indicative of beam shapes or directions explicitly for set A beams and set B beams or may include information indicative of relative beam direction or width information regarding the set A beams and the set B beams. In some aspects, the information indicative of the beam shape correspondence information may depend on whether the CSI report setting 230 is associated with periodic, semi-persistent, or aperiodic CSI reports 245.

For a CSI report setting 230 associated with any of periodic, semi-persistent, or aperiodic CSI reports 245, the correspondence information may be directly indicated for each pair of {CMR set, CPR set}. For example, the correspondence information may be indicated via the CSI report setting information 235 or via other control signaling from one or both of the TRP 205-a and the TRP 205-b. For a CSI report setting 230 associated with semi-persistent CSI reports 245, the correspondence information may be indicated by an activating MAC-CE (which may optionally also indicate a selection of the pairs of {CMR set, CPR set}). For example, the activating MAC-CE may indicate the correspondence information for each pair of {CMR set, CPR set} that is activated by the MAC-CE (e.g., each pair of {CMR set, CPR set} to actually be used of the various {CMR set, CPR set} pairs configured). For a CSI report setting 230 associated with aperiodic CSI reports 245, the aperiodic CSI triggering state configurations (which may optionally also indicate a selection of the pairs of {CMR set, CPR set}) associated with the CSI report setting 230 may indicate the correspondence information associated with each selected or triggered CMR set, CPR set} pair (e.g., such that correspondence information is indicated for each pair of {CMR set, CPR set} to actually be used of the various {CMR set, CPR set} pairs configured).

The beam shape association or correspondence information may be explicitly indicated or differentially indicated (e.g., via explicit or differential association). In some implementations, the beam shape correspondence information may explicitly indicate beam point direction and beam width information of the CMR sets 210 and the CPR sets 215. Additionally, or alternatively, the beam shape correspondence information may implicitly indicate differences of beam point direction or beam widths among the resources in the CMR sets 210 and the CPR sets 215. Additionally, or alternatively, the beam shape correspondence information may indicate QCL relationships among the resources in the CMR sets 210 and the CPR sets 215. In some implementations, the UE 115 may receive an indication or configuration of a serving cell-specific beamforming codebook including multiple choices of beam pointing direction or beam width and, in such implementations, the beam shape correspondence information may indicate codepoints in the codebook for respective resources included in the CMR sets 210 and the CPR sets 215 to indicate the correspondence information.

In accordance with receiving the information indicative of the CSI report setting 230, the indications of the associations or pairings between CMR sets 210 and CPR sets 215, and the beam shape association or correspondence information between {CMR set, CPR set} pairs, the UE 115 may receive one or more reference signals 240 from the TRP 205-a and the TRP 205-b via channel resources of the CMR set 210-a and the CMR set 210-b, respectively, and measure a set of signal strengths of the received reference signals 240. In some implementations, the TRP 205-a may transmit a set of reference signals 240 using beams 220-a via channel resources of the CMR set 210-a and the TRP 205-b may transmit a set of reference signals 240 using beams 220-b via channel resources of the CMR set 210-b.

The UE 115 may use the channel measurement information associated with the CMR set 210-a and the CMR set 210-b (as obtained via the measurements of the reference signals 240) to predict at least a signal strength associated with one or more CPRs of the CPR set 215-a or the CPR set 215-b. In other words, for example, the UE 115 may use measurements of the beams 220-a sent via the CMR set 210-a to predict signal strengths of the set of beams 225-a associated with the CPR set 215-a and may use measurements of the beams 220-b sent via the CMR set 210-b to predict signal strengths of the set of beams 225-b associated with the CPR set 215-b. In some aspects, the UE 115 may use an AI or ML model or algorithm to predict the signal strengths of the set of beams 225-a and the set of beams 225-b.

In some implementations, the UE 115 may predict a signal strength (e.g., an L1-RSRP or an L1-SINR) associated with pair-wise CPRs. A CPR pair may refer to two CPRs, each associated with a different CPR set 215, that the UE 115 may group or pair together (e.g., indicate as a pair) via a CSI report 245, where a pairing of two CPRs may imply or indicate, to the TRP 205-a and the TRP 205-b, that the UE 115 is capable of receiving signaling via beams associated with the two CPRs simultaneously. In other words, the UE 115 may select a first CPR in a CPR pair from the CPR set 215-a and a second CPR in a CPR pair from the CPR set 215-b such that the UE 115 is capable of receiving via a first CPR and a second CPR of a CPR pair simultaneously. In some implementations, the UE 115 may perform the prediction of the signal strengths (e.g., the L1-RSRPs/L1-SINRs) regarding CPRs in the CPR set 215-a and the CPR set 215-b based, at least in part, on the channel measurements associated with CMRs in the CMR set 210-a and the CMR set 210-b, respectively. In other words, the UE 115 may predict signal strengths for CPRs of the CPR set 215-a based on measurements of the CMRs of the CMR set 210-a and may predict signal strengths for CPRs of the CPR set 215-b based on measurements of the CMRs of the CMR set 210-b.

In accordance with obtaining measured signal strengths of at least a subset of CMRs of the CMR set 210-a and the CMR set 210-b and predicted signal strengths of at least a subset of CPRs of the CPR set 215-a and the CPR set 215-b, the UE 115 may report, via a CSI report 245 associated with the CSI report setting 230, one or multiple pairs of predicted pair-wise signal strengths (e.g., L1-RSRPs/L1-SINRs) together with corresponding CPR identifiers associated with the respective CPR sets 215. In some implementations, the UE 115 may further report a CPR set identifier associated with a strongest predicted signal strength among a set of (e.g., all) predicted pair-wise signal strengths. Additionally, in some implementations, the UE 115 may include group-based mTRP reporting associated with the CMR set 210-a and the CMR set 210-b in the CSI report 245.

The UE 115, the TRP 205-a, and the TRP 205-b may support various quantization schemes or formatting schemes for predicted and measured signal strengths that the UE 115 indicates via the CSI report 245. In some implementations, the UE 115, the TRP 205-a, and the TRP 205-b may use a first quantization scheme or format associated with indicating one reported signal strength absolutely and the rest of the reported signal strengths differentially relative to the absolutely indicated signal strength. In such implementations, the absolutely indicated signal strength may be the greatest of the reported signal strengths and may be associated with a CMR set 210 or a CPR set 215. In some other implementations, the UE 115 the TRP 205-a, and the TRP 205-b may use a second quantization scheme or format associated with indicating one reported signal strength absolutely and the rest of the reported signal strengths differentially relative to the absolutely indicated signal strength for each of the CMR sets 210 and the CPR sets 215.

In implementations in which the UE 115, the TRP 205-a, and the TRP 205-b employ the first quantization scheme, the UE 115 may include a bit to indicate whether the strongest (either predicted or measured) signal strength is from the CPR sets 215 or the CMR sets 210. The UE 115 may further report the CMR or CPR set identifier associated with the strongest measured or predicted signal strength. Additionally, the UE 115 may report the pair-wise signal strengths, where the pair including or associated with the strongest signal strength may be reported first (e.g., first in order), and where a strongest signal strength and associated with CMR or CPR identifier may be reported prior to the paired CMR or CPR.

In such implementations, the UE 115 may report the strongest signal strength via X1 bits (e.g., 7 bits) absolutely and may report the remaining signal strengths via X2 bits (e.g., 4 bits) differentially referring to (e.g., relative to) the strongest signal strength. In some aspects, a quantity of bits included for reporting CMR or CPR identifiers depends on the total quantity of CMRs and CPRs included in the respective CMR and CPR sets. In some implementations, the UE 115, the TRP 205-a, and the TRP 205-b may, in accordance with a configuration or a default interpretation, expect that the strongest signal strength is associated with the CPR sets 215. Additional details relating to such a first quantization scheme are illustrated by Table 2.1 and Table 2.2, shown below. A combination or concatenation of Table 2.1 and Table 2.2 may illustrate the CSI report 245 in examples in which both measured signal strengths and predicted signal strengths are carried in the CSI report 245.

TABLE 2.1
Example First Portion of CSI Report

| 1-bit indicator | | | | |
|---|---|---|---|---|
| whether the | 1-bit indicator of the | CPR IDs across 2 CPR sets | | |
| strongest L1-RSRP | CMR/CPR set associated | | CPR set #1 | CPR set #2 |
| comes from CMRs | with the strongest L1-RSRP | | (3-bits per | (3-bits per |
| or CPRs | across all CMRs | | CPR-ID) | CPR-ID) |
| “0” → CMR set | “0” → CMR/CPR set #1 | Pair #1 | CPR#1 | CPR#5 |
| “1” → CPR set | “1” → CMR/CPR set #2 | Pair #2 | CPR#2 | CPR#6 |

TABLE 2.2
Example Second Portion of CSI Report 245

| CMR IDs across 2 CMR sets | | | Absolute L1- | |
|---|---|---|---|---|
| | CMR set #1 | CMR set #2 | RSRP for the | Differential |
| | (2-bits per | (2-bits per | strongest | L1-RSRPs for |
| | CMR-ID) | CMR-ID) | beam | other beams |
| Pair #3 | CMR#1 | CMR#5 | 7-bits for | |
| | | | CPR#1 | |
| Pair #4 | CMR#2 | CMR#6 | | 4-bits for each |
| | | | | of the remaining |
| | | | | CMRs/CPRs |

In implementations in which the UE 115, the TRP 205-a, and the TRP 205-b employ the second quantization scheme, the UE 115 may separately report signal strengths (e.g., L1-RSRPs or L1-SINRs) for CMRs and CPRs. For example, the UE 115 may separately report the {CMR set ID, CPR set ID} including the strongest {measured, predicted} signal strengths. In other words, the UE 115 may report, via absolute indications, the strongest signal strengths associated with the CMRs and the CPRs, respectively. The UE 115 may format other aspects of the CSI report 245 similarly to the mTRP L1 reporting framework of the first quantization scheme, with the difference that the UE 115 may report two sets of information for measured and predicted signal strengths and CMR IDs+CPR IDs, respectively.

In other words, the UE 115 may absolutely indicate a first signal strength associated with CPRs and may differentially, relative to the first signal strength, indicate signal strengths for each of a remaining set of CPRs reported via the CSI report 245 and may absolutely indicate a second signal strength associated with the reported CMRs and may differentially, relatively to the second signal strength, indicate signal strengths for each of a remaining set of CMRs reported via the CSI report. In such examples, the first signal strength may be a greatest CPR signal strength from among the reported CPR signal strengths and the second signal strength may be a greatest reported CMR signal strength from among the reported CMR signal strengths. Further, a quantity of bits that the UE 115 may use for reporting CMR or CPR IDs may depend on a quantity of CMRs and CPRs included in the respective CMR and CPR sets.

In some other implementations, the UE 115 may use different quantization schemes for measured and predicted signal strengths. For example, the quantization schemes, which may refer to the quantity of bits used for absolute and differential signal strength quantization, and the associated quantization step-size and range) may be different for measured and predicted signal strengths. In other words, the UE 115 may use a first quantization scheme for measured signal strengths and a second quantization scheme for predicted signal strengths. In such implementations, the UE 115, the TRP 205-a and the TRP 205-b may support multiple quantization options (e.g., in accordance with configuration signaling or a network specification) and a network entity 105 may indicate two options to the UE 115, each to be applied to measured signal strengths and predicted signal strengths, respectively.

In an example, the UE 115 may use different quantities of bits for each absolute or differential signal strength indication for measured signal strengths and predicted signal strengths. In some aspects, for instance, the UE 115 may use X1 bits for an absolute indication of a measured or predicted signal strength, may use X2 bits for differential indications of measured signal strengths, and may use X3 bits for differential indications of predicted signal strengths. In some aspects, X2 may be greater than X3 (e.g., X2=4 and ×3=4), as predicted signal strengths may be associated with a relatively lower confidence level than measured signal strengths, such that less accuracy for lower signaling overhead may be relatively more suitable for predicted signal strengths than measured signal strengths.

In some implementations, the UE 115, the TRP 205-a, and the TRP 205-b may support confidence level reporting associated with the signal strength predictions made by the UE 115 associated with the reported CPRs. In some aspects, the UE 115 may report a standard deviation or variance associated with the predicted signal strengths (which may be normalized or non-normalized). Additionally, or alternatively, the UE 115 may report a confidence level that is exclusively for the strongest reported predicted signal strength or may report confidence levels associated with a set of (e.g., all) reported predicted signal strengths, respectively (such that each reported predicted signal strength is associated with a corresponding confidence level). Additionally, or alternatively, the UE 115 may report a single confidence level associated with a set of (e.g., all) reported predicted signal strengths, jointly considering the set of (e.g., all) reported precited signal strengths.

Further, although described in the context of examples including two CMR sets 210 and two CPR sets 215, the UE 115, the TRP 205-a, and the TRP 205-b may employ the described techniques in scenarios in which the UE 115 may report information associated with more than two CMR sets 210 or more than two CPR sets 215. In other words, the UE 115, the TRP 205-a, and the TRP 205-b may communicate configuration information via the CSI report setting information 235, transmit or receive reference signals 240, and communicate measurement and prediction information via the CSI report 245 associated with more than two pairs of {CMR set, CPR set}. In such implementations, the quantity of bits that the UE 115 may include in the CSI report 245 may depend on how many {CMR set, CPR set} pairs for which the UE 115 includes measurement and prediction information. For example, the number of bits may increase as the quantity of reported {CMR set, CPR set} pairs increases, and the quantity of bits used may be determined or selected similarly to how a quantity of bits used to indicate a CMR or CPR ID is determined or selected.

Further, although illustrated by and described in the context of the TRP 205-a being associated with the CMR set 210-a and the CPR set 215-a and the TRP 205-b being associated with the CMR set 210-b and the CPR set 215-b, the described techniques may also apply to scenarios in which a subset of one or more CMR sets 210 is associated with CPR sets 215. For example, in some implementations, only subsets of one or more CMR sets 210 may be paired with CPR sets 215, while a remaining set of CMR sets 210 may not be paired with CPR sets. In an example, the CMR set 210-a may be associated with the CPR set 215-a and the CMR set 210-b may not be associated with any CPR set 215.

The UE 115, the TRP 205-a, and the TRP 205-b may support such variation in whether a CMR set 210 is paired with a CPR set 215 in accordance with one or more signaling mechanisms. In some implementations, each CMR set 210 may be initially paired with a CPR set 215 in the CSI report setting 230 (e.g., the RRC configured CSI report setting 230) and a MAC-CE activating a semi-persistent CSI report 245 or an aperiodic CSI triggering state configuration may disable one or more paired CPR sets 215 for a specified (e.g., indicated) one or more CMR sets 210. In such implementations, the UE 115 may receive, from at least one of the TRP 205-a or the TRP 205-b, an indication of the initial pairing of each CMR set 210 to a CPR set 215 via the CSI report setting information 235.

In some other implementations, each CMR set 210 may not be initially paired with a CPR set 215 in the CSI report setting 230 and a MAC-CE activating a semi-persistent CSI report 245 or an aperiodic CSI triggering state configuration may indicate one or more CPR set IDs that are paired with a respective one or more CMR sets 210. In such implementations, the CSI report setting information 235 may not indicate the association between CMR sets 210 and CPR sets 215 and, instead, additional signal (e.g., an activating MAC-CE or a triggering message, such as a DCI message) may indicate associations (e.g., pairings) between one or more CMR sets 210 and one or more CPR sets 215. Further, in such implementations, the activating MAC-CE or the aperiodic CSI triggering state may indicate beam shape correspondence information for each indicated {CMR set, CPR set} pair.

In some implementations, one or more CMR sets 210 in the CSI report setting 230 may not be paired with a respective CPR set 215. In some aspects, the UE 115, the TRP 205-a, and the TRP 205-b may selectively configure (or not configure) or selectively enable (or disable) an association or pairing for a given CMR set 210 based on a quantity of narrow beams associated with a corresponding TRP 205. For example, if the set of beams 225-a of the TRP 205-a is relatively large (e.g., includes greater than a threshold quantity of beams), the TRP 205-a and the UE 115 may support an association or pairing between the CMR set 210-a and the CPR set 215-a. If the set of beams 225-b of the TRP 205-b is relatively small (e.g., includes less than a threshold quantity of beams), the TRP 205-b and the UE 115 may refrain from supporting an association or pairing of the CMR set 210-b. As such, the UE 115, the TRP 205-a, and the TRP 205-b may selectively configure or enable associations or pairings to a corresponding CMR set 210 (to configure or enable prediction of an associated or paired second set of beams 225) based on relative signaling overhead and measurement-related power consumption costs at the UE 115.

In such implementations in which the UE 115, the TRP 205-a, and the TRP 205-b use a CSI report setting 230 in which at least one CMR set 210 is not associated or paired with a corresponding CPR set 215, the UE 115 may report a mixture of measured and predicted signal strength pairs or groups and the UE 115 may report the pairs or groups such that the UE 115 may be able to receive via the reported paired or grouped CMRs or CPRs simultaneously. In such implementations, as is implementations in which each CMR set 210 is associated or paired with a corresponding CPR set 215, the UE 115 may use a same quantization scheme for measured and predicted signal strengths or may use different quantization schemes for measured signal strengths and for predicted signal strengths.

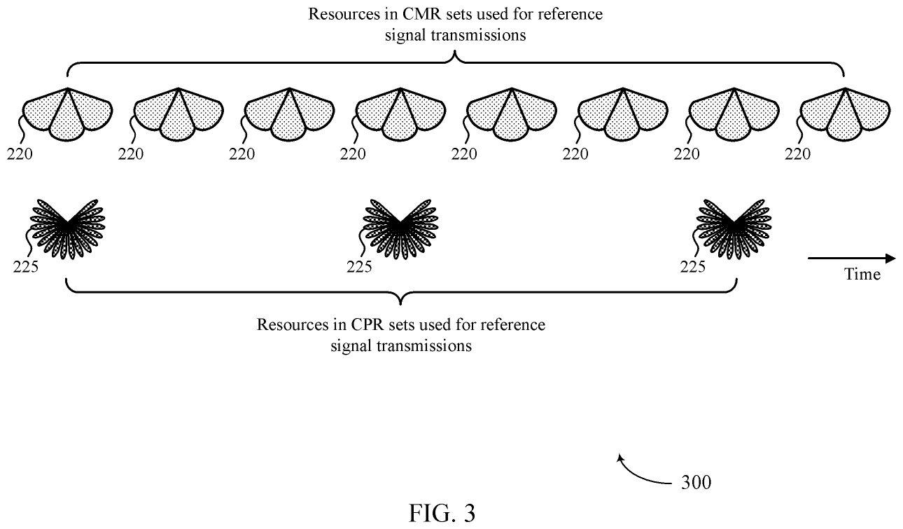

FIG. 3 illustrates an example of a channel resource set timeline 300 that supports CSI reporting for mTRP-based beam prediction in accordance with one or more aspects of the present disclosure. The channel resource set timeline 300 may implement or be implemented to facilitate or realize aspects of the wireless communications system 100 or the wireless communications system 200. For example, the channel resource set timeline 300 illustrates a timeline or a periodicity of a CMR set 210, which may be associated with a set of beams 220, and a CPR set 215, which may be associated with a set of beams 225. In the example of FIG. 3, the CMR set 210 and the CPR set 215 may be paired or associated with each other.

In some implementations, a TRP 205 (e.g., the TRP 205-a or the TRP 205-b as illustrated by and described with reference to FIG. 2) may transmit a set of one or more reference signals using the set of beams 220 via channel resources of the CMR set 210 and a UE 115 (e.g., the UE 115 as illustrated by and described with reference to FIGS. 1 and 2) may use measurements of the channel resources of the CMR set 210 to predict signal strengths associated with the set of beams 225, each of which may be associated with a channel resource of the CPR set 215. In some implementations, the CPR set 215 may include a set of actual resources. For example, the channel resources included in the CPR set 215 may also be CMRs (e.g., NZP-CSI-RS or SSB resources) that are associated with relatively longer periodicities than the CMRs of the CMR set 210. As such, the TRP 205 may transmit one or more reference signals via the set of beams 225 using CPRs of the CPR set 215, but with a greater periodicity than the TRP 205 may use to transmit reference signals via the set of beams 220 using CMRs of the CMR set 210.

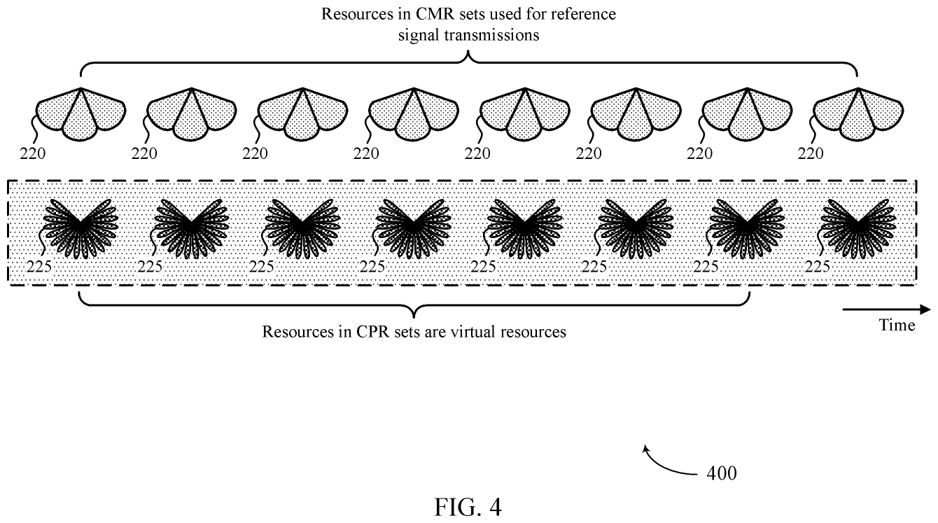

FIG. 4 illustrates an example of a channel resource set timeline 400 that supports CSI reporting for mTRP-based beam prediction in accordance with one or more aspects of the present disclosure. The channel resource set timeline 400 may implement or be implemented to facilitate or realize aspects of the wireless communications system 100 or the wireless communications system 200. For example, the channel resource set timeline 300 illustrates a timeline or a periodicity of a CMR set 210, which may be associated with a set of beams 220, and a CPR set 215, which may be associated with a set of beams 225. In the example of FIG. 4, the CMR set 210 and the CPR set 215 may be paired or associated with each other.

In some implementations, a TRP 205 (e.g., the TRP 205-a or the TRP 205-b as illustrated by and described with reference to FIG. 2) may transmit a set of one or more reference signals using the set of beams 220 via channel resources of the CMR set 210 and a UE 115 (e.g., the UE 115 as illustrated by and described with reference to FIGS. 1 and 2) may use measurements of the channel resources of the CMR set 210 to predict signal strengths associated with the set of beams 225, each of which may be associated with a channel resource of the CPR set 215. In some implementations, the CPR set 215 may include a set of virtual resources. For example, the resources included in the CPR set 215 may be virtual resources that are not expected to be transmitted by the TRP 205 and not expected to be received by the UE 115. In such implementations, the CMR set 210 and the CPR set 215 may be associated with same periodicities, as the periodicity of the CPR set 215 may not impact signaling overhead or measurement-related power consumption costs at the UE 115 due to the CPR set 215 including virtual resources that are not actually transmitted or received.

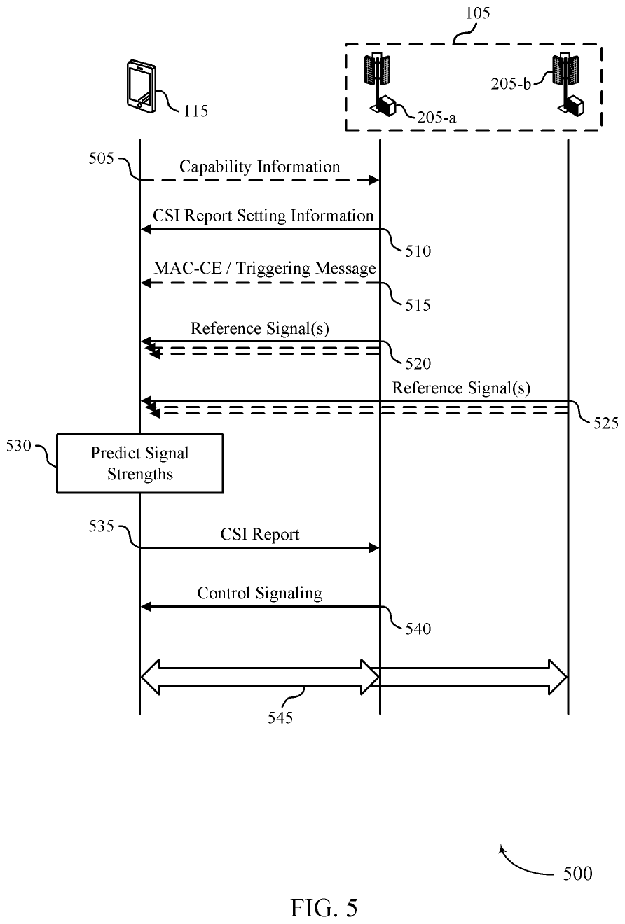

FIG. 5 illustrates an example of a process flow 500 that supports CSI reporting for mTRP-based beam prediction in accordance with one or more aspects of the present disclosure. The process flow 500 may implement or be implanted to facilitate or realize aspects of the wireless communications system 100, the wireless communications system 200, the channel resource set timeline 300, and the channel resource set timeline 400. For example, the process flow: 500 illustrates communication between a UE 115, a TRP 205-a, and a TRP 205-b, which may be examples of corresponding devices as illustrated by and described with reference to FIGS. 1 through 4. In some deployments, the TRP 205-a and the TRP 205-b may be associated with (e.g., a component of or controlled by) a network entity 105. In some implementations, the UE 115, the TRP 205-a, and the TRP 205-b may support one or more configuration- or signaling-based mechanisms according to which the UE 115, the TRP 205-a, and the TRP 205-b may support set A and set B beam association and group-based L1 report (e.g., a group-based L1-RSRP/L1-SINR report) for mTRP beam prediction. As described herein, any one or more of the UE 115, the TRP 205-a, and the TRP 205-b may be referred to or understood as a network node.

In the following description of the process flow 500, the operations may be performed (such as reported or provided) in a different order than the order shown, or the operations performed by the example devices may be performed in different orders or at different times. Some operations also may be left out of the process flow 500, or other operations may be added to the process flow 500. Further, although some operations or signaling may be shown to occur at different times for discussion purposes, these operations may actually occur at the same time.

At 505, the UE 115 may transmit capability information indicative of an upper limit quantity of CSI reports associated with beam prediction for which the UE 115 is capable of simultaneously being configured or activated. In some aspects, the quantity of channel resource pairs included in a CSI report may be associated with (e.g., depend on) the upper limit quantity of CSI reports the UE 115 is capable of. The UE 115 may transmit the capability information to the TRP 205-a or the TRP 205-b, or the network entity 105 associated with the TRP 205-a and the TRP 205-b, via various types of uplink signaling, including uplink control information (UCI), a MAC-CE, an uplink data channel, an uplink shared channel, or a random access channel.

At 510, the UE 115 may receive CSI report setting information, which may indicate information indicative of a CSI report setting, such as the CSI report setting 230 as illustrated by and described with reference to FIG. 2. In some implementations, the CSI report setting information may be associated with a first channel resource set for channel measurement and a second channel resource set for channel measurement. As described herein, such channel resource sets for channel measurement may be examples of CMR sets, such as the CMR set 210-a and the CMR set 210-b as illustrated by and described with reference to FIG. 2. In some implementations, the first channel resource set may be associated with a third channel resource set for beam prediction and the second channel resource set may be associated with a fourth channel resource set for beam prediction. As described herein, such channel resource sets for beam prediction may be examples of CPR sets, such as the CPR set 215-a and the CPR set 215-b as illustrated by and described with reference to FIG. 2.

The UE 115 may receive the CSI report setting information from the TRP 205-a or the TRP 205-b, or the network entity 105 associated with the TRP 205-a and the TRP 205-b, via one or more messages. In implementations in which the UE 115 receives the CSI report setting information via multiple messages, each message of the multiple messages may include a different portion of the CSI report setting information. In such implementations, multiple messages may refer to separately signaled messages or different IEs or parameters that each carry different portions of the CSI report setting information. In some aspects, the UE 115 may receive the CSI report setting information via RRC signaling.

At 515, the UE 115 may, in some implementations, receive a MAC-CE or a triggering message (e.g., a DCI message) associated with activating or triggering the CSI report setting. In some implementations, the MAC-CE or triggering message may indicate an activation or selection of a first channel resource set pair that includes the first channel resource set and the third channel resource set and of a second channel resource set pair that includes the second channel resource set and the fourth channel resource set. In other words, in such implementations, the MAC-CE or the triggering message may indicate the association or pairing between CMRs and CPRs. In some aspects, the MAC-CE or triggering message may further indicate the third channel resource set and the fourth channel resource set. The UE 115 may receive the MAC-CE or the triggering message from the TRP 205-a, the TRP 205-b, or the network entity 105 associated with the TRP 205-a and the TRP 205-b.

At 520 and 525, the UE 115 may receive a set of one or more reference signals from each of the TRP 205-a and the TRP 205-b via channel resources of the first channel resource set and the second channel resource set, respectively (e.g., if the first channel resource set is associated with the TRP 205-a and the second channel resource set is associated with the TRP 205-b). The UE 115 may perform or otherwise obtain channel measurements of the channel resources of the first and second channel resource sets using the reference signals received from the TRP 205-a and the TRP 205-b. For example, the UE 115 may obtain a set of L1-RSRP or L1-SINR values associated with the channel resources of the first and second channel resource sets.

At 530, the UE 115 may predict, based on the set of channel measurements associated with the channel resources of the first and second channel resource sets, a respective signal strength associated with each respective channel resource of one or more channel resource pairs, where each of the one or more channel resource pairs includes a respective first channel resource from the third channel resource set and a respective second channel resource from the fourth channel resource set. In other words, the UE 115 may predict signal strengths associated with pair-wise CPRs.

At 535, the UE 115 may transmit a CSI report that indicates predicted signal strengths of at least one channel resource pair of the one or more channel resource pairs. In some implementations, the UE 115 may additionally include, in the CSI report, measured signal strengths associated with one or more second channel resource pairs, where each channel resource pair of the one or more second channel resource pairs includes a respective first channel resource from the first channel resource set and a respective second channel resource from the second channel resource set. In some implementations, the UE 115 may use one or more quantization schemes associated with the measured and predicted signal strengths included in the CSI report. The UE 115 may transmit the CSI report to the TRP 205-a, the TRP 205-b, or the network entity 105 associated with the TRP 205-a and the TRP 205-b.

At 540, the UE 115 may receive control signaling associated with which directional beams are to be used for communication with one or both of the TRP 205-a and the TRP 205-b. For example, the UE 115 may receive information indicative of which beams the TRP 205-a or the TRP 205-b are to use for communication with the UE 115 based on the CSI report (e.g., based on the predicted signal strengths). Additionally, or alternatively, the control signaling may indicate which beams the UE 115 may use for communication with the TRP 205-a or the TRP 205-b based on the CSI report (e.g., based on the predicted signal strengths). The UE 115 may receive the control signaling from the TRP 205-a, the TRP 205-b, or the network entity 105 associated with the TRP 205-a and the TRP 205-b via DCI, a MAC-CE, a downlink control channel, a downlink data channel, or a downlink shared channel.

At 545, the UE 115 may communicate with the TRP 205-a and the TRP 205-b in accordance with the control signaling and based on the CSI report. For example, the UE 115 may receive downlink signaling from the TRP 205-a and the TRP 205-b via TRP beams that the UE 115 predicted to have relatively higher signal strengths in the CSI report, or beams that are otherwise indicated via the control signaling. The UE 115 may communicate with the TRP 205-a and the TRP 205-b via one or more control, data, or shared channels.

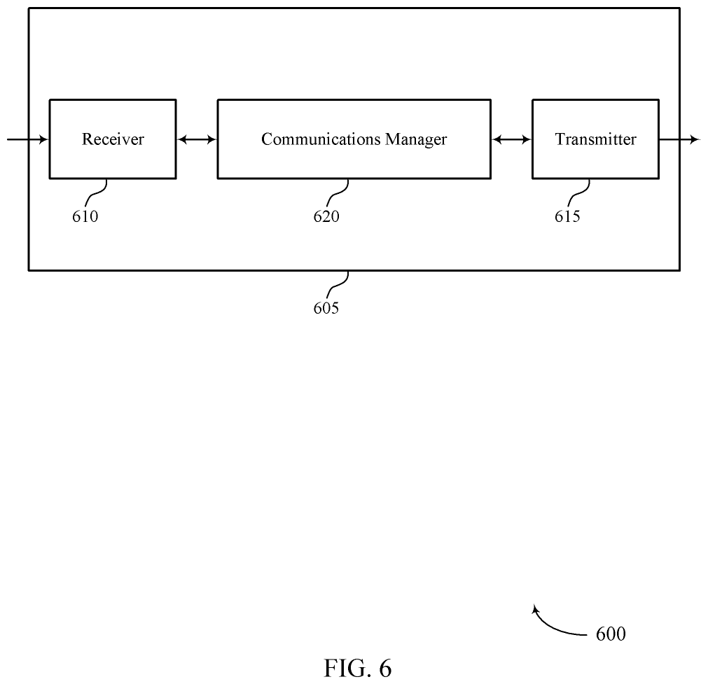

FIG. 6 shows a block diagram 600 of a device 605 that supports CSI reporting for mTRP-based beam prediction in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to CSI reporting for mTRP-based beam prediction). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to CSI reporting for mTRP-based beam prediction). In some implementations, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of CSI reporting for mTRP-based beam prediction as described herein. For example, the communications manager 620, the receiver 610, the transmitter 615, or various combinations or components thereof may support a method for performing one or more of the functions described herein.

In some implementations, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some implementations, a processor and memory coupled with the processor may be configured to perform one or more of the functions described herein (e.g., by executing, by the processor, instructions stored in the memory).

Additionally, or alternatively, In some implementations, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some implementations, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a network node in accordance with examples as disclosed herein. For example, the communications manager 620 may be configured as or otherwise support a means for receiving CSI report setting information, where the CSI report setting information is associated with a first channel resource set for channel measurement and a second channel resource set for channel measurement, and where the first channel resource set is associated with a third channel resource set for beam prediction and the second channel resource set is associated with a fourth channel resource set for beam prediction. The communications manager 620 may be configured as or otherwise support a means for predicting, based on a set of channel measurements associated with channel resources of the first channel resource set and the second channel resource set, a respective signal strength associated with each respective channel resource of one or more channel resource pairs, where each of the one or more channel resource pairs includes a respective first channel resource from the third channel resource set and a respective second channel resource from the fourth channel resource set. The communications manager 620 may be configured as or otherwise support a means for transmitting a CSI report including information indicative of predicted signal strengths of at least one channel resource pair of the one or more channel resource pairs.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for reduced processing, reduced power consumption, and more efficient utilization of communication resources.

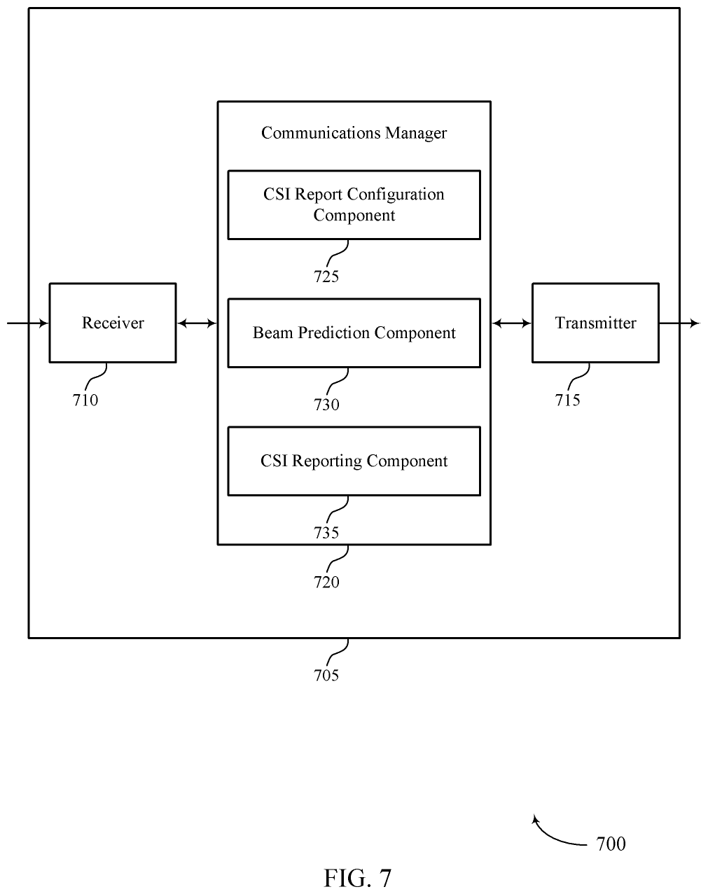

FIG. 7 shows a block diagram 700 of a device 705 that supports CSI reporting for mTRP-based beam prediction in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to CSI reporting for mTRP-based beam prediction). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to CSI reporting for mTRP-based beam prediction). In some implementations, the transmitter 715 may be co-located with a receiver 710 in a transceiver module. The transmitter 715 may utilize a single antenna or a set of multiple antennas.

The device 705, or various components thereof, may be an example of means for performing various aspects of CSI reporting for mTRP-based beam prediction as described herein. For example, the communications manager 720 may include a CSI report configuration component 725, a beam prediction component 730, a CSI reporting component 735, or any combination thereof. The communications manager 720 may be an example of aspects of a communications manager 620 as described herein. In some implementations, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a network node in accordance with examples as disclosed herein. The CSI report configuration component 725 may be configured as or otherwise support a means for receiving CSI report setting information, where the CSI report setting information is associated with a first channel resource set for channel measurement and a second channel resource set for channel measurement, and where the first channel resource set is associated with a third channel resource set for beam prediction and the second channel resource set is associated with a fourth channel resource set for beam prediction. The beam prediction component 730 may be configured as or otherwise support a means for predicting, based on a set of channel measurements associated with channel resources of the first channel resource set and the second channel resource set, a respective signal strength associated with each respective channel resource of one or more channel resource pairs, where each of the one or more channel resource pairs includes a respective first channel resource from the third channel resource set and a respective second channel resource from the fourth channel resource set. The CSI reporting component 735 may be configured as or otherwise support a means for transmitting a CSI report including information indicative of predicted signal strengths of at least one channel resource pair of the one or more channel resource pairs.

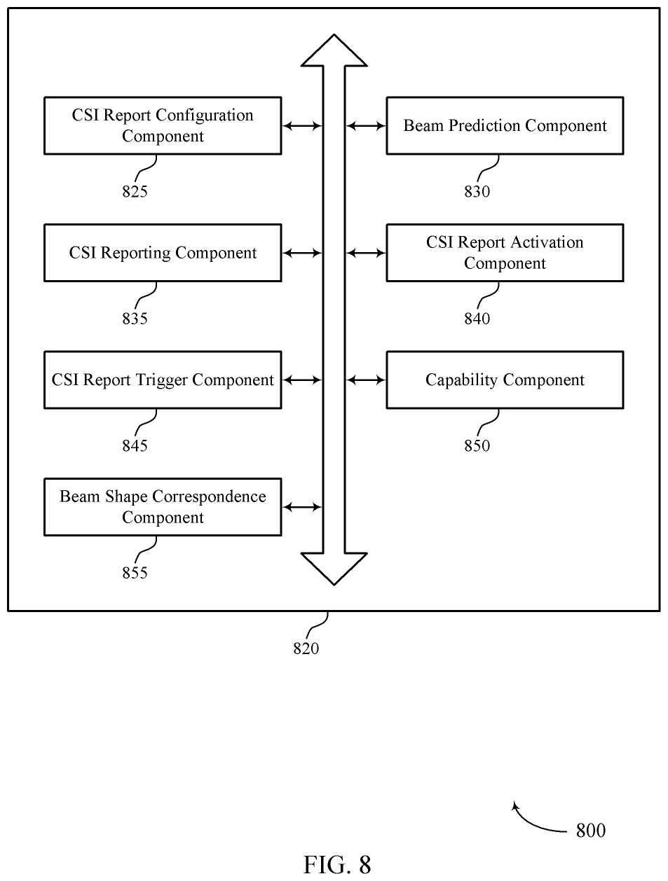

FIG. 8 shows a block diagram 800 of a communications manager 820 that supports CSI reporting for mTRP-based beam prediction in accordance with one or more aspects of the present disclosure. The communications manager 820 may be an example of aspects of a communications manager 620, a communications manager 720, or both, as described herein. The communications manager 820, or various components thereof, may be an example of means for performing various aspects of CSI reporting for mTRP-based beam prediction as described herein. For example, the communications manager 820 may include a CSI report configuration component 825, a beam prediction component 830, a CSI reporting component 835, a CSI report activation component 840, a CSI report trigger component 845, a capability component 850, a beam shape correspondence component 855, or any combination thereof. Each of these components may communicate, directly or indirectly, with one another (e.g., via one or more buses).

The communications manager 820 may support wireless communication at a network node in accordance with examples as disclosed herein. The CSI report configuration component 825 may be configured as or otherwise support a means for receiving CSI report setting information, where the CSI report setting information is associated with a first channel resource set for channel measurement and a second channel resource set for channel measurement, and where the first channel resource set is associated with a third channel resource set for beam prediction and the second channel resource set is associated with a fourth channel resource set for beam prediction. The beam prediction component 830 may be configured as or otherwise support a means for predicting, based on a set of channel measurements associated with channel resources of the first channel resource set and the second channel resource set, a respective signal strength associated with each respective channel resource of one or more channel resource pairs, where each of the one or more channel resource pairs includes a respective first channel resource from the third channel resource set and a respective second channel resource from the fourth channel resource set. The CSI reporting component 835 may be configured as or otherwise support a means for transmitting a CSI report including information indicative of predicted signal strengths of at least one channel resource pair of the one or more channel resource pairs.

In some implementations, the CSI reporting setting information includes information indicative of the first channel resource set, information indicative of the second channel resource set, information indicative of the third channel resource set, and information indicative of the fourth channel resource set. In some implementations, receiving the CSI report setting information includes receiving a single CSI report setting message including the CSI report setting information.

In some implementations, to support receiving the CSI report setting information, the CSI report configuration component 825 may be configured as or otherwise support a means for receiving a first CSI report setting message that includes information indicative of the first channel resource set and the second channel resource set. In some implementations, to support receiving the CSI report setting information, the CSI report configuration component 825 may be configured as or otherwise support a means for receiving a second CSI report setting message that includes information indicative of the third channel resource set and the fourth channel resource set.

In some implementations, the CSI report setting information includes information indicative of a first association between the first channel resource set and the third channel resource set and information indicative of a second association between the second channel resource set and the fourth channel resource set.

In some implementations, the CSI report activation component 840 may be configured as or otherwise support a means for receiving, via a MAC-CE configured to activate the first channel resource set and the second channel resource set, an activation of: a first channel resource set pair that includes the first channel resource set and the third channel resource set, and a second channel resource set pair that includes the second channel resource set and the fourth channel resource set.

In some implementations, the CSI report trigger component 845 may be configured as or otherwise support a means for receiving, via a message associated with an aperiodic trigger state associated with the first channel resource set and the second channel resource set, information indicative of: a first channel resource set pair that includes the first channel resource set and the third channel resource set, and a second channel resource set pair that includes the second channel resource set and the fourth channel resource set.

In some implementations, the CSI report setting information includes information indicative of a set of multiple channel resource sets for channel measurement. In some implementations, the set of multiple channel resource sets include the first channel resource set and the second channel resource set. In some implementations, a first subset of the set of multiple channel resource sets are associated with a corresponding channel resource set for beam prediction and a second subset of the set of multiple channel resource sets are not associated with a corresponding channel resource set for beam prediction.

In some implementations, the CSI report configuration component 825 may be configured as or otherwise support a means for receiving, via a MAC-CE that activates the first channel resource set and the second channel resource set or a message associated with an aperiodic trigger state associated with the first channel resource set and the second channel resource set, information indicative of the third channel resource set and the fourth channel resource set, information indicative of a first association between the first channel resource set and the third channel resource set, and information indicative of a second association between the second channel resource set and the fourth channel resource set.

In some implementations, the capability component 850 may be configured as or otherwise support a means for transmitting capability information indicative of an upper limit quantity of CSI reports associated with beam prediction, where a quantity of the at least one channel resource pair of the one or more channel resource pairs included in the CSI report is associated with the upper limit quantity of CSI reports associated with beam prediction.

In some implementations, the CSI report includes information indicative of measured signal strengths of one or more second channel resource pairs. In some implementations, each of the one or more second channel resource pairs includes a respective first channel resource from the first channel resource set and a respective second channel resource from the second channel resource set.

In some implementations, the CSI report includes a first indication of whether a greatest signal strength is associated with a channel measurement or a channel measurement prediction and includes a second indication of which channel resource set the greatest signal strength is associated with. In some implementations, the second indication indicates one of the first channel resource set or the second channel resource set if the first indication indicates that the greatest signal strength is associated with the channel measurement and indicates one of the third channel resource set or the fourth channel resource set if the first indication indicates that the greatest signal strength is associated with the channel measurement prediction.

In some implementations, the CSI report includes an absolute indication of the greatest signal strength and includes a set of differential indications, relative to the greatest signal strength, of a remaining set of signal strengths of channel resources of the at least one channel resource pair and the one or more second channel resource pairs. In some implementations, the absolute indication includes a first quantity of bits and each of the set of differential indications includes a second quantity of bits less than the first quantity of bits.

In some implementations, the CSI report includes a first absolute indication of a first signal strength associated with a channel measurement prediction and includes a second absolute indication of a second signal strength associated with a channel measurement. In some implementations, the first signal strength is a greatest signal strength relative to a remaining set of predicted signal strengths of channel resources of the at least one channel resource pair and the second signal strength is a greatest signal strength relative to a remaining set of measured signal strengths of channel resources of the one or more second channel resource pairs.

In some implementations, the CSI report includes a first set of differential indications, relative to the first signal strength, of the remaining set of predicted signal strengths of channel resources of the at least one channel resource pair and a second set of differential indications, relative to the second signal strength, of the remaining set of measured signal strengths of channel resources of the one or more second channel resource pairs.

In some implementations, each of the first set of differential indications includes a first quantity of bits and each of the second set of differential indications includes a second quantity of bits different from the first quantity of bits.

In some implementations, the beam shape correspondence component 855 may be configured as or otherwise support a means for receiving first information associated with a first beam shape correspondence between the first channel resource set and the third channel resource set. In some implementations, the beam shape correspondence component 855 may be configured as or otherwise support a means for receiving second information associated with a second beam shape correspondence between the second channel resource set and the fourth channel resource set.

In some implementations, receiving the first information and the second information includes receiving the first information and the second information via the CSI report setting information, a MAC-CE that configured to activate the first channel resource set and the second channel resource set, or a message associated with an aperiodic trigger state associated with the first channel resource set and the second channel resource set.

In some implementations, the channel resources of the first channel resource set and the second channel resource set are associated with first reference signal transmissions at a first periodicity. In some implementations, second channel resources of the third channel resource set and the fourth channel resource set are associated with second reference signal transmissions at a second periodicity. In some implementations, the second periodicity is greater than the first periodicity.

In some implementations, the channel resources of the first channel resource set and the second channel resource set are associated with first reference signal transmissions at a first periodicity. In some implementations, second channel resources of the third channel resource set and the fourth channel resource set are associated with an absence of any reference signal transmissions.

In some implementations, the CSI report includes information indicative of a confidence level associated with one or more channel resources of the at least one channel resource pair associated with beam prediction.

In some implementations, the first channel resource set and the third channel resource set are associated with a first TRP and the second channel resource set and the fourth channel resource set are associated with a second TRP.

In some implementations, receiving the CSI report setting information includes receiving the CSI report setting information over one or more messages. In some implementations, each of the one or more messages includes at least a portion of the CSI report setting information.

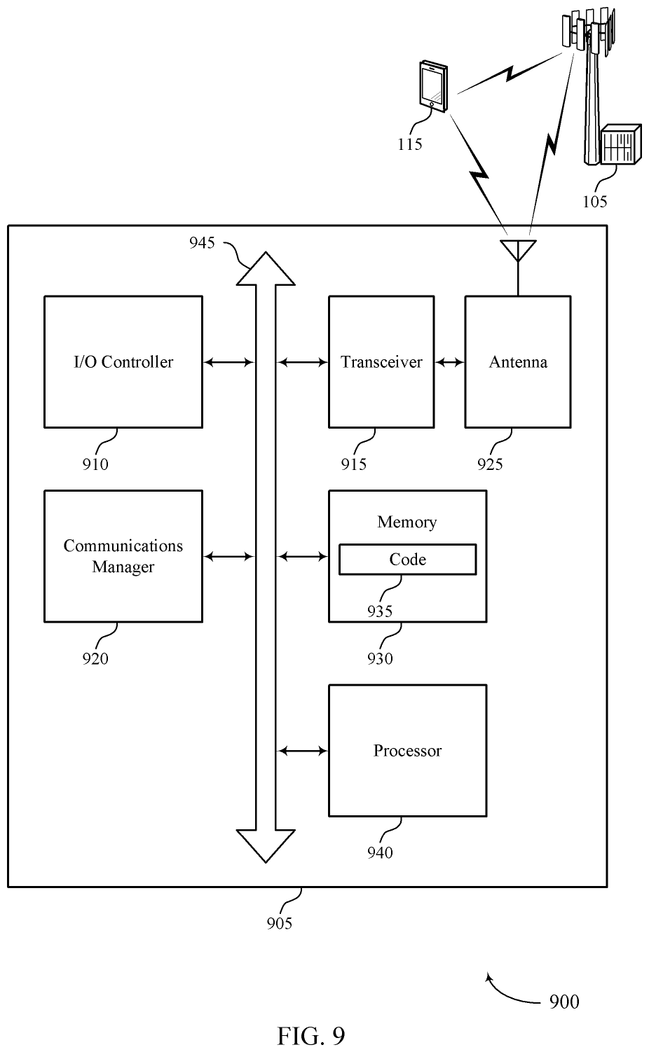

FIG. 9 shows a diagram of a system 900 including a device 905 that supports CSI reporting for mTRP-based beam prediction in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOSR, ANDROIDR, MS-DOSR, MS-WINDOWS®, OS/2R, UNIX®, LINUXR, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting CSI reporting for mTRP-based beam prediction). For example, the device 905 or a component of the device 905 may include a processor 940 and memory 930 coupled with or to the processor 940, the processor 940 and memory 930 configured to perform various functions described herein.

The communications manager 920 may support wireless communication at a network node in accordance with examples as disclosed herein. For example, the communications manager 920 may be configured as or otherwise support a means for receiving CSI report setting information, where the CSI report setting information is associated with a first channel resource set for channel measurement and a second channel resource set for channel measurement, and where the first channel resource set is associated with a third channel resource set for beam prediction and the second channel resource set is associated with a fourth channel resource set for beam prediction. The communications manager 920 may be configured as or otherwise support a means for predicting, based on a set of channel measurements associated with channel resources of the first channel resource set and the second channel resource set, a respective signal strength associated with each respective channel resource of one or more channel resource pairs, where each of the one or more channel resource pairs includes a respective first channel resource from the third channel resource set and a respective second channel resource from the fourth channel resource set. The communications manager 920 may be configured as or otherwise support a means for transmitting a CSI report including information indicative of predicted signal strengths of at least one channel resource pair of the one or more channel resource pairs.

By including or configuring the communications manager 920 in accordance with examples as described herein, the device 905 may support techniques for improved communication reliability, reduced latency, improved user experience related to reduced processing, reduced power consumption, more efficient utilization of communication resources, improved coordination between devices, longer battery life, and improved utilization of processing capability.

In some implementations, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, In some implementations, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of CSI reporting for mTRP-based beam prediction as described herein, or the processor 940 and the memory 930 may be otherwise configured to perform or support such operations.

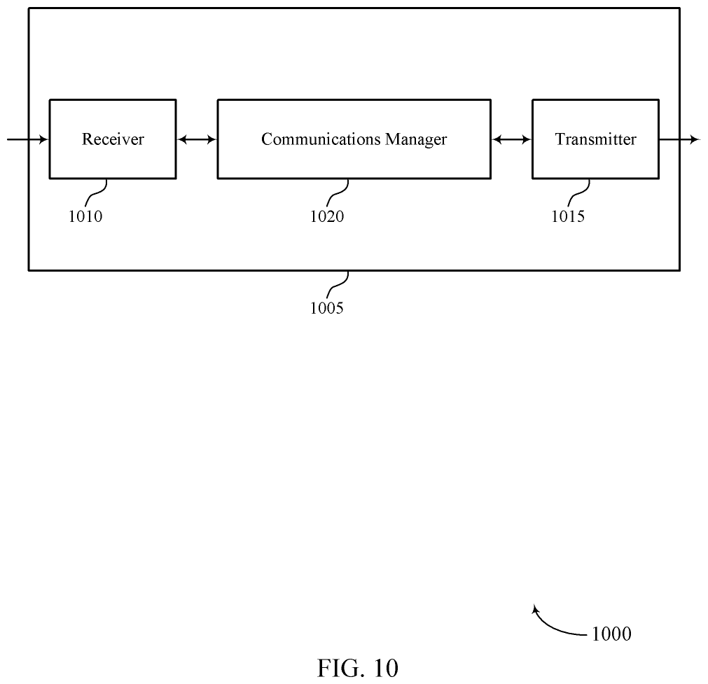

FIG. 10 shows a block diagram 1000 of a device 1005 that supports CSI reporting for mTRP-based beam prediction in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some implementations, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some implementations, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some implementations, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of CSI reporting for mTRP-based beam prediction as described herein. For example, the communications manager 1020, the receiver 1010, the transmitter 1015, or various combinations or components thereof may support a method for performing one or more of the functions described herein.

In some implementations, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some implementations, a processor and memory coupled with the processor may be configured to perform one or more of the functions described herein (e.g., by executing, by the processor, instructions stored in the memory).

Additionally, or alternatively, In some implementations, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some implementations, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network node in accordance with examples as disclosed herein. For example, the communications manager 1020 may be configured as or otherwise support a means for transmitting CSI report setting information, where the CSI report setting information is associated with a first channel resource set for channel measurement and a second channel resource set for channel measurement, and where the first channel resource set is associated with a third channel resource set for beam prediction and the second channel resource set is associated with a fourth channel resource set for beam prediction. The communications manager 1020 may be configured as or otherwise support a means for receiving a CSI report including information indicative of predicted signal strengths of at least one channel resource pair, where each of the at least one channel resource pair includes a respective first channel resource from the third channel resource set and a respective second channel resource from the fourth channel resource set.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for reduced processing, reduced power consumption, and more efficient utilization of communication resources.

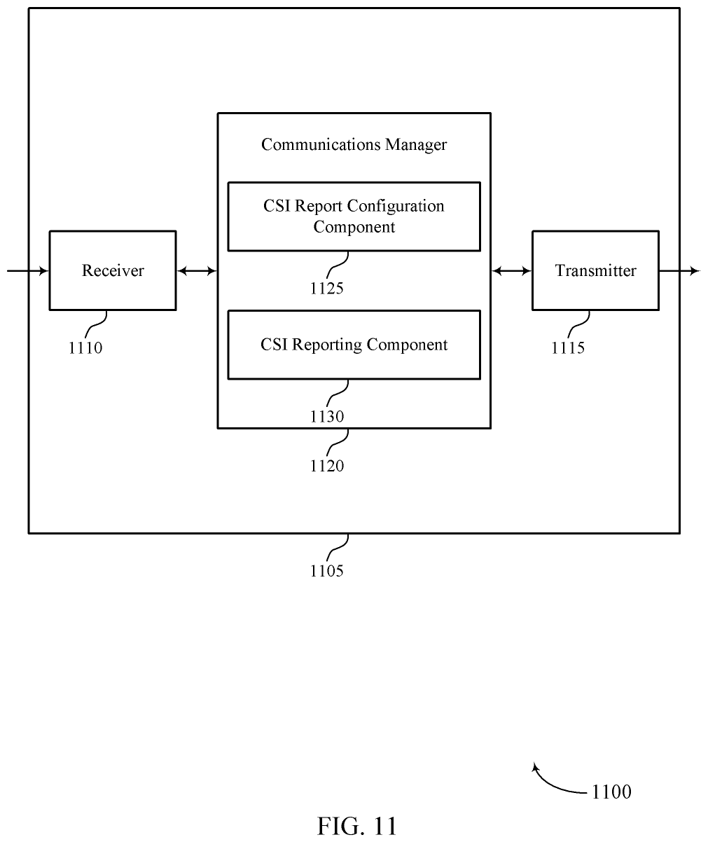

FIG. 11 shows a block diagram 1100 of a device 1105 that supports CSI reporting for mTRP-based beam prediction in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some implementations, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some implementations, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some implementations, the transmitter 1115 and the receiver 1110 may be co-located in a transceiver, which may include or be coupled with a modem.

The device 1105, or various components thereof, may be an example of means for performing various aspects of CSI reporting for mTRP-based beam prediction as described herein. For example, the communications manager 1120 may include a CSI report configuration component 1125 a CSI reporting component 1130, or any combination thereof. The communications manager 1120 may be an example of aspects of a communications manager 1020 as described herein. In some implementations, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network node in accordance with examples as disclosed herein. The CSI report configuration component 1125 may be configured as or otherwise support a means for transmitting CSI report setting information, where the CSI report setting information is associated with a first channel resource set for channel measurement and a second channel resource set for channel measurement, and where the first channel resource set is associated with a third channel resource set for beam prediction and the second channel resource set is associated with a fourth channel resource set for beam prediction. The CSI reporting component 1130 may be configured as or otherwise support a means for receiving a CSI report including information indicative of predicted signal strengths of at least one channel resource pair, where each of the at least one channel resource pair includes a respective first channel resource from the third channel resource set and a respective second channel resource from the fourth channel resource set.

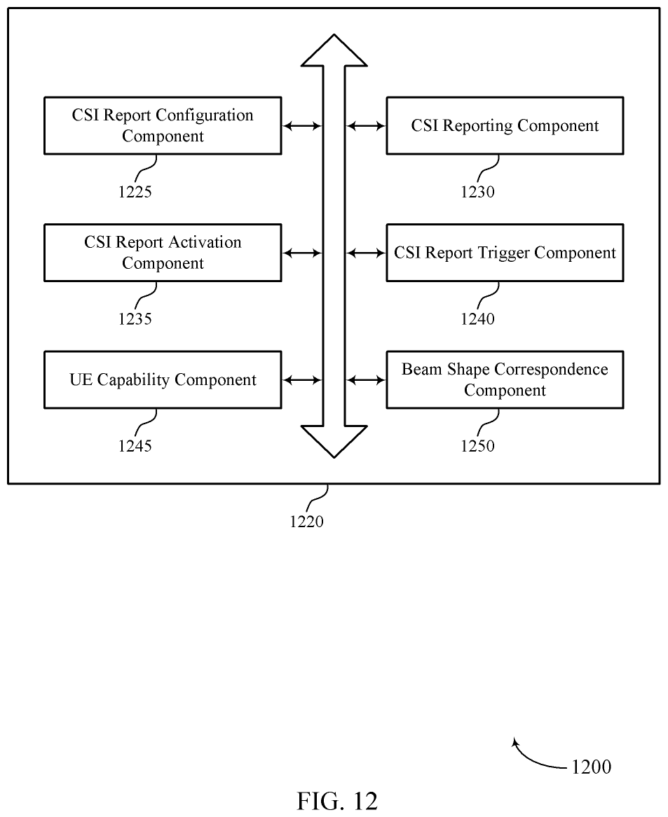

FIG. 12 shows a block diagram 1200 of a communications manager 1220 that supports CSI reporting for mTRP-based beam prediction in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of CSI reporting for mTRP-based beam prediction as described herein. For example, the communications manager 1220 may include a CSI report configuration component 1225, a CSI reporting component 1230, a CSI report activation component 1235, a CSI report trigger component 1240, a UE capability component 1245, a beam shape correspondence component 1250, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communication at a network node in accordance with examples as disclosed herein. The CSI report configuration component 1225 may be configured as or otherwise support a means for transmitting CSI report setting information, where the CSI report setting information is associated with a first channel resource set for channel measurement and a second channel resource set for channel measurement, and where the first channel resource set is associated with a third channel resource set for beam prediction and the second channel resource set is associated with a fourth channel resource set for beam prediction. The CSI reporting component 1230 may be configured as or otherwise support a means for receiving a CSI report including information indicative of predicted signal strengths of at least one channel resource pair, where each of the at least one channel resource pair includes a respective first channel resource from the third channel resource set and a respective second channel resource from the fourth channel resource set.

In some implementations, the CSI reporting setting information includes information indicative of the first channel resource set, information indicative of the second channel resource set, information indicative of the third channel resource set, and information indicative of the fourth channel resource set. In some implementations, receiving the CSI report setting information includes receiving a single CSI report setting message including the CSI report setting information.

In some implementations, to support transmitting the CSI report setting information, the CSI report configuration component 1225 may be configured as or otherwise support a means for transmitting a first CSI report setting message that includes information indicative of the first channel resource set and the second channel resource set. In some implementations, to support transmitting the CSI report setting information, the CSI report configuration component 1225 may be configured as or otherwise support a means for transmitting a second CSI report setting message that includes information indicative of the third channel resource set and the fourth channel resource set.

In some implementations, the CSI report setting information includes information indicative of a first association between the first channel resource set and the third channel resource set and information indicative of a second association between the second channel resource set and the fourth channel resource set.

In some implementations, the CSI report activation component 1235 may be configured as or otherwise support a means for transmitting, via a MAC-CE configured to activate the first channel resource set and the second channel resource set, an activation of: a first channel resource set pair that includes the first channel resource set and the third channel resource set, and a second channel resource set pair that includes the second channel resource set and the fourth channel resource set.

In some implementations, the CSI report trigger component 1240 may be configured as or otherwise support a means for transmitting, via a message associated with an aperiodic trigger state associated with the first channel resource set and the second channel resource set, information indicative of: a first channel resource set pair that includes the first channel resource set and the third channel resource set, and a second channel resource set pair that includes the second channel resource set and the fourth channel resource set.

In some implementations, the CSI report setting information includes information indicative of a set of multiple channel resource sets for channel measurement. In some implementations, the set of multiple channel resource sets include the first channel resource set and the second channel resource set. In some implementations, a first subset of the set of multiple channel resource sets are associated with a corresponding channel resource set for beam prediction and a second subset of the set of multiple channel resource sets are not associated with a corresponding channel resource set for beam prediction.

In some implementations, the CSI report configuration component 1225 may be configured as or otherwise support a means for transmitting, via a MAC-CE that activates the first channel resource set and the second channel resource set or a message associated with an aperiodic trigger state associated with the first channel resource set and the second channel resource set, information indicative of the third channel resource set and the fourth channel resource set, information indicative of a first association between the first channel resource set and the third channel resource set, and information indicative of a second association between the second channel resource set and the fourth channel resource set.

In some implementations, the UE capability component 1245 may be configured as or otherwise support a means for receiving capability information indicative of an upper limit quantity of CSI reports associated with beam prediction, where a quantity of the at least one channel resource pair of the one or more channel resource pairs included in the CSI report is associated with the upper limit quantity of CSI reports associated with beam prediction.

In some implementations, the CSI report setting information includes information indicative of measured signal strengths of one or more second channel resource pairs. In some implementations, each of the one or more second channel resource pairs includes a respective first channel resource from the first channel resource set and a respective second channel resource from the second channel resource set.

In some implementations, the CSI report includes a first indication of whether a greatest signal strength is associated with a channel measurement or a channel measurement prediction and includes a second indication of which channel resource set the greatest signal strength is associated with. In some implementations, the second indication indicates one of the first channel resource set or the second channel resource set if the first indication indicates that the greatest signal strength is associated with the channel measurement and indicates one of the third channel resource set or the fourth channel resource set if the first indication indicates that the greatest signal strength is associated with the channel measurement prediction.

In some implementations, the CSI report includes an absolute indication of the greatest signal strength and includes a set of differential indications, relative to the greatest signal strength, of a remaining set of signal strengths of channel resources of the at least one channel resource pair and the one or more second channel resource pairs. In some implementations, the absolute indication includes a first quantity of bits and each of the set of differential indications includes a second quantity of bits less than the first quantity of bits.

In some implementations, the CSI report includes a first absolute indication of a first signal strength associated with a channel measurement prediction and includes a second absolute indication of a second signal strength associated with a channel measurement. In some implementations, the first signal strength is a greatest signal strength relative to a remaining set of predicted signal strengths of channel resources of the at least one channel resource pair and the second signal strength is a greatest signal strength relative to a remaining set of measured signal strengths of channel resources of the one or more second channel resource pairs.

In some implementations, the CSI report includes a first set of differential indications, relative to the first signal strength, of the remaining set of predicted signal strengths of channel resources of the at least one channel resource pair and a second set of differential indications, relative to the second signal strength, of the remaining set of measured signal strengths of channel resources of the one or more second channel resource pairs.

In some implementations, each of the first set of differential indications includes a first quantity of bits and each of the second set of differential indications includes a second quantity of bits different from the first quantity of bits.

In some implementations, the beam shape correspondence component 1250 may be configured as or otherwise support a means for transmitting first information associated with a first beam shape correspondence between the first channel resource set and the third channel resource set. In some implementations, the beam shape correspondence component 1250 may be configured as or otherwise support a means for transmitting second information associated with a second beam shape correspondence between the second channel resource set and the fourth channel resource set.

In some implementations, transmitting the first information and the second information includes transmitting the first information and the second information via the CSI report setting information, a MAC-CE configured to activate the first channel resource set and the second channel resource set, or a message associated with an aperiodic trigger state associated with the first channel resource set and the second channel resource set.

In some implementations, the channel resources of the first channel resource set and the second channel resource set are associated with first reference signal transmissions at a first periodicity. In some implementations, second channel resources of the third channel resource set and the fourth channel resource set are associated with second reference signal transmissions at a second periodicity. In some implementations, the second periodicity is greater than the first periodicity.

In some implementations, the channel resources of the first channel resource set and the second channel resource set are associated with first reference signal transmissions at a first periodicity. In some implementations, second channel resources of the third channel resource set and the fourth channel resource set are associated with an absence of any reference signal transmissions.

In some implementations, the CSI report includes information indicative of a confidence level associated with one or more channel resources of the at least one channel resource pair associated with beam prediction.

In some implementations, the first channel resource set and the third channel resource set are associated with a first TRP and the second channel resource set and the fourth channel resource set are associated with a second TRP.

In some implementations, transmitting the CSI report setting information includes transmitting the CSI report setting information over one or more messages. In some implementations, each of the one or more messages includes at least a portion of the CSI report setting information.

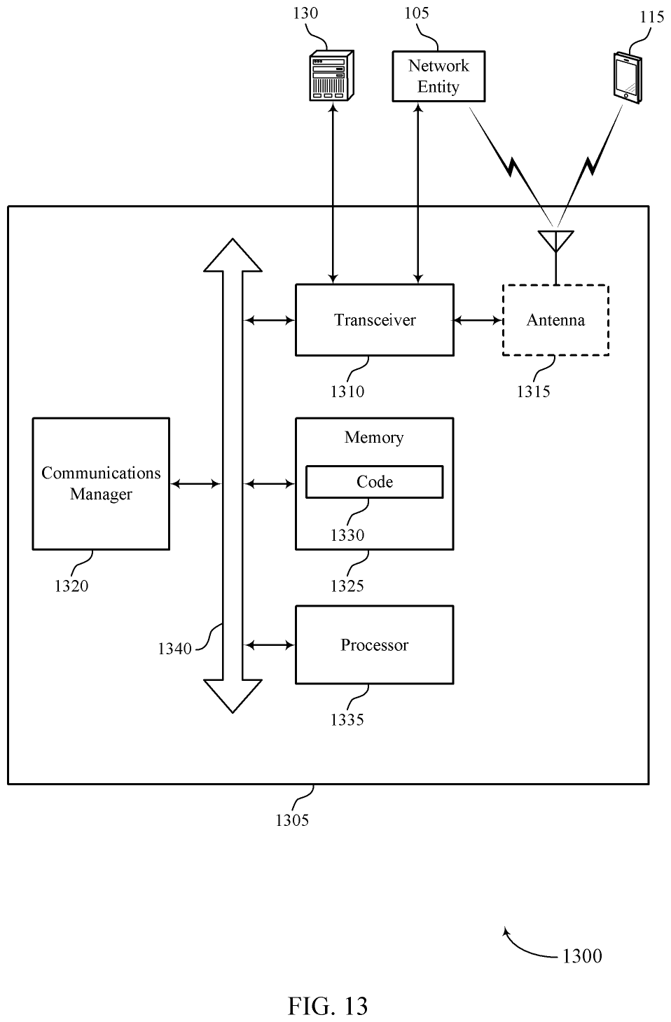

FIG. 13 shows a diagram of a system 1300 including a device 1305 that supports CSI reporting for mTRP-based beam prediction in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some implementations, the transceiver 1310 may include a wired transceiver and may communicate bi-directionally with another wired transceiver. Additionally, or alternatively, In some implementations, the transceiver 1310 may include a wireless transceiver and may communicate bi-directionally with another wireless transceiver. In some implementations, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or memory components (for example, the processor 1335, or the memory 1325, or both), may be included in a chip or chip assembly that is installed in the device 1305. In some implementations, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting CSI reporting for mTRP-based beam prediction). For example, the device 1305 or a component of the device 1305 may include a processor 1335 and memory 1325 coupled with the processor 1335, the processor 1335 and memory 1325 configured to perform various functions described herein.

The processor 1335 may be an example of a cloud-computing platform (e.g., one or more physical nodes and supporting software such as operating systems, virtual machines, or container instances) that may host the functions (e.g., by executing code 1330) to perform the functions of the device 1305. The processor 1335 may be any one or more suitable processors capable of executing scripts or instructions of one or more software programs stored in the device 1305 (such as within the memory 1325). In some implementations, the processor 1335 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the processor 1335, or the transceiver 1310, or the communications manager 1320, or other components or combinations of components of the device 1305.

The processing system of the device 1305 may interface with other components of the device 1305, and may process information received from other components (such as inputs or signals) or output information to other components. For example, a chip or modem of the device 1305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations.

In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

In some implementations, a bus 1340 may support communications of (e.g., within) a protocol layer of a protocol stack. In some implementations, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some implementations, the communications manager 1320 may manage aspects of communications with a core network 130 (e.g., via one or more wired or wireless backhaul links). For example, the communications manager 1320 may manage the transfer of data communications for client devices, such as one or more UEs 115. In some implementations, the communications manager 1320 may manage communications with other network entities 105, and may include a controller or scheduler for controlling communications with UEs 115 in cooperation with other network entities 105. In some implementations, the communications manager 1320 may support an X2 interface within an LTE/LTE-A wireless communications network technology to provide communication between network entities 105.

The communications manager 1320 may support wireless communication at a network node in accordance with examples as disclosed herein. For example, the communications manager 1320 may be configured as or otherwise support a means for transmitting CSI report setting information, where the CSI report setting information is associated with a first channel resource set for channel measurement and a second channel resource set for channel measurement, and where the first channel resource set is associated with a third channel resource set for beam prediction and the second channel resource set is associated with a fourth channel resource set for beam prediction. The communications manager 1320 may be configured as or otherwise support a means for receiving a CSI report including information indicative of predicted signal strengths of at least one channel resource pair, where each of the at least one channel resource pair includes a respective first channel resource from the third channel resource set and a respective second channel resource from the fourth channel resource set.

By including or configuring the communications manager 1320 in accordance with examples as described herein, the device 1305 may support techniques for improved communication reliability, reduced latency, improved user experience related to reduced processing, reduced power consumption, more efficient utilization of communication resources, improved coordination between devices, longer battery life, and improved utilization of processing capability.

In some implementations, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, In some implementations, one or more functions described with reference to the communications manager 1320 may be supported by or performed by the transceiver 1310, the processor 1335, the memory 1325, the code 1330, or any combination thereof. For example, the code 1330 may include instructions executable by the processor 1335 to cause the device 1305 to perform various aspects of CSI reporting for mTRP-based beam prediction as described herein, or the processor 1335 and the memory 1325 may be otherwise configured to perform or support such operations.

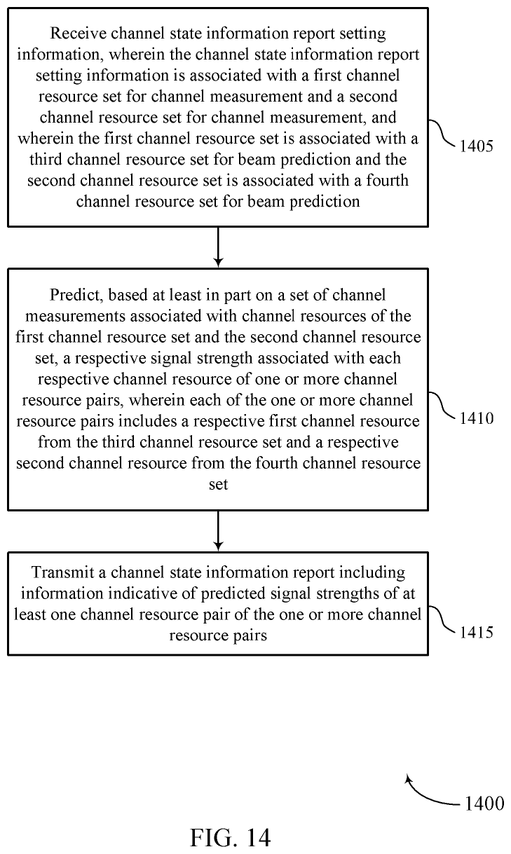

FIG. 14 shows a flowchart illustrating a method 1400 that supports CSI reporting for mTRP-based beam prediction in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some implementations, a UE may execute a set of instructions to control the functional elements of the UE to perform the described functions. Additionally, or alternatively, the UE may perform aspects of the described functions using special-purpose hardware.

At 1405, the method may include receiving CSI report setting information, where the CSI report setting information is associated with a first channel resource set for channel measurement and a second channel resource set for channel measurement, and where the first channel resource set is associated with a third channel resource set for beam prediction and the second channel resource set is associated with a fourth channel resource set for beam prediction. The operations of 1405 may be performed in accordance with examples as disclosed herein. In some implementations, aspects of the operations of 1405 may be performed by a CSI report configuration component 825 as described with reference to FIG. 8.

At 1410, the method may include predicting, based on a set of channel measurements associated with channel resources of the first channel resource set and the second channel resource set, a respective signal strength associated with each respective channel resource of one or more channel resource pairs, where each of the one or more channel resource pairs includes a respective first channel resource from the third channel resource set and a respective second channel resource from the fourth channel resource set. The operations of 1410 may be performed in accordance with examples as disclosed herein. In some implementations, aspects of the operations of 1410 may be performed by a beam prediction component 830 as described with reference to FIG. 8.

At 1415, the method may include transmitting a CSI report including information indicative of predicted signal strengths of at least one channel resource pair of the one or more channel resource pairs. The operations of 1415 may be performed in accordance with examples as disclosed herein. In some implementations, aspects of the operations of 1415 may be performed by a CSI reporting component 835 as described with reference to FIG. 8.

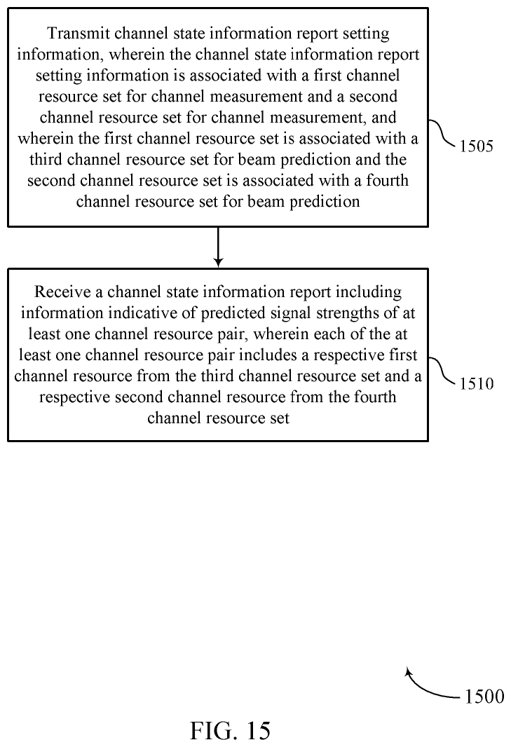

FIG. 15 shows a flowchart illustrating a method 1500 that supports CSI reporting for mTRP-based beam prediction in accordance with one or more aspects of the present disclosure. The operations of the method 1500 may be implemented by a network entity or its components as described herein. For example, the operations of the method 1500 may be performed by a network entity as described with reference to FIGS. 1 through 5 and 10 through 13. In some implementations, a network entity may execute a set of instructions to control the functional elements of the network entity to perform the described functions. Additionally, or alternatively, the network entity may perform aspects of the described functions using special-purpose hardware.

At 1505, the method may include transmitting CSI report setting information, where the CSI report setting information is associated with a first channel resource set for channel measurement and a second channel resource set for channel measurement, and where the first channel resource set is associated with a third channel resource set for beam prediction and the second channel resource set is associated with a fourth channel resource set for beam prediction. The operations of 1505 may be performed in accordance with examples as disclosed herein. In some implementations, aspects of the operations of 1505 may be performed by a CSI report configuration component 1225 as described with reference to FIG. 12.

At 1510, the method may include receiving a CSI report including information indicative of predicted signal strengths of at least one channel resource pair, where each of the at least one channel resource pair includes a respective first channel resource from the third channel resource set and a respective second channel resource from the fourth channel resource set. The operations of 1510 may be performed in accordance with examples as disclosed herein. In some implementations, aspects of the operations of 1510 may be performed by a CSI reporting component 1230 as described with reference to FIG. 12.

The following provides an overview of aspects of the present disclosure:
Aspect 1: A method for wireless communication at a network node, comprising: receiving CSI report setting information, wherein the CSI report setting information is associated with a first channel resource set for channel measurement and a second channel resource set for channel measurement, and wherein the first channel resource set is associated with a third channel resource set for beam prediction and the second channel resource set is associated with a fourth channel resource set for beam prediction: predicting, based at least in part on a set of channel measurements associated with channel resources of the first channel resource set and the second channel resource set, a respective signal strength associated with each respective channel resource of one or more channel resource pairs, wherein each of the one or more channel resource pairs includes a respective first channel resource from the third channel resource set and a respective second channel resource from the fourth channel resource set; and transmitting a CSI report including information indicative of predicted signal strengths of at least one channel resource pair of the one or more channel resource pairs.
Aspect 2: The method of aspect 1, wherein the CSI reporting setting information includes information indicative of the first channel resource set, information indicative of the second channel resource set, information indicative of the third channel resource set, and information indicative of the fourth channel resource set, receiving the CSI report setting information comprises receiving a single CSI report setting message including the CSI report setting information.
Aspect 3: The method of any of aspects 1 through 2, wherein receiving the CSI report setting information comprises: receiving a first CSI report setting message that includes information indicative of the first channel resource set and the second channel resource set; and receiving a second CSI report setting message that includes information indicative of the third channel resource set and the fourth channel resource set.
Aspect 4: The method of any of aspects 1 through 3, wherein the CSI report setting information includes information indicative of a first association between the first channel resource set and the third channel resource set and information indicative of a second association between the second channel resource set and the fourth channel resource set.
Aspect 5: The method of any of aspects 1 through 4, further comprising: receiving, via a MAC-CE configured to activate the first channel resource set and the second channel resource set, an activation of: a first channel resource set pair that includes the first channel resource set and the third channel resource set, and a second channel resource set pair that includes the second channel resource set and the fourth channel resource set.
Aspect 6: The method of any of aspects 1 through 5, further comprising: receiving, via a message associated with an aperiodic trigger state associated with the first channel resource set and the second channel resource set, information indicative of: a first channel resource set pair that includes the first channel resource set and the third channel resource set, and a second channel resource set pair that includes the second channel resource set and the fourth channel resource set.
Aspect 7: The method of any of aspects 1 through 6, wherein the CSI report setting information includes information indicative of a plurality of channel resource sets for channel measurement, the plurality of channel resource sets include the first channel resource set and the second channel resource set, and a first subset of the plurality of channel resource sets are associated with a corresponding channel resource set for beam prediction and a second subset of the plurality of channel resource sets are not associated with a corresponding channel resource set for beam prediction.
Aspect 8: The method of any of aspects 1 through 7, further comprising: receiving, via a MAC-CE that activates the first channel resource set and the second channel resource set or a message associated with an aperiodic trigger state associated with the first channel resource set and the second channel resource set, information indicative of the third channel resource set and the fourth channel resource set, information indicative of a first association between the first channel resource set and the third channel resource set, and information indicative of a second association between the second channel resource set and the fourth channel resource set.
Aspect 9: The method of any of aspects 1 through 8, further comprising: transmitting capability information indicative of an upper limit quantity of CSI reports associated with beam prediction, wherein a quantity of the at least one channel resource pair of the one or more channel resource pairs included in the CSI report is associated with the upper limit quantity of CSI reports associated with beam prediction.
Aspect 10: The method of any of aspects 1 through 9, wherein the CSI report includes information indicative of measured signal strengths of one or more second channel resource pairs, each of the one or more second channel resource pairs includes a respective first channel resource from the first channel resource set and a respective second channel resource from the second channel resource set.
Aspect 11: The method of aspect 10, wherein the CSI report includes a first indication of whether a greatest signal strength is associated with a channel measurement or a channel measurement prediction and includes a second indication of which channel resource set the greatest signal strength is associated with, the second indication indicates one of the first channel resource set or the second channel resource set if the first indication indicates that the greatest signal strength is associated with the channel measurement and indicates one of the third channel resource set or the fourth channel resource set if the first indication indicates that the greatest signal strength is associated with the channel measurement prediction.
Aspect 12: The method of aspect 11, wherein the CSI report includes an absolute indication of the greatest signal strength and includes a set of differential indications, relative to the greatest signal strength, of a remaining set of signal strengths of channel resources of the at least one channel resource pair and the one or more second channel resource pairs, the absolute indication includes a first quantity of bits and each of the set of differential indications includes a second quantity of bits less than the first quantity of bits.
Aspect 13: The method of aspect 10, wherein the CSI report includes a first absolute indication of a first signal strength associated with a channel measurement prediction and includes a second absolute indication of a second signal strength associated with a channel measurement, the first signal strength is a greatest signal strength relative to a remaining set of predicted signal strengths of channel resources of the at least one channel resource pair and the second signal strength is a greatest signal strength relative to a remaining set of measured signal strengths of channel resources of the one or more second channel resource pairs.
Aspect 14: The method of aspect 13, wherein the CSI report includes a first set of differential indications, relative to the first signal strength, of the remaining set of predicted signal strengths of channel resources of the at least one channel resource pair and a second set of differential indications, relative to the second signal strength, of the remaining set of measured signal strengths of channel resources of the one or more second channel resource pairs.

Aspect 15: The method of aspect 14, wherein each of the first set of differential indications includes a first quantity of bits and each of the second set of differential indications includes a second quantity of bits different from the first quantity of bits.

Aspect 16: The method of any of aspects 1 through 15, further comprising: receiving first information associated with a first beam shape correspondence between the first channel resource set and the third channel resource set; and receiving second information associated with a second beam shape correspondence between the second channel resource set and the fourth channel resource set.

Aspect 17: The method of aspect 16, wherein receiving the first information and the second information comprises receiving the first information and the second information via the CSI report setting information, a MAC-CE that configured to activate the first channel resource set and the second channel resource set, or a message associated with an aperiodic trigger state associated with the first channel resource set and the second channel resource set.

Aspect 18: The method of any of aspects 1 through 17, wherein the channel resources of the first channel resource set and the second channel resource set are associated with first reference signal transmissions at a first periodicity, second channel resources of the third channel resource set and the fourth channel resource set are associated with second reference signal transmissions at a second periodicity, and the second periodicity is greater than the first periodicity.

Aspect 19: The method of any of aspects 1 through 17, wherein the channel resources of the first channel resource set and the second channel resource set are associated with first reference signal transmissions at a first periodicity, and second channel resources of the third channel resource set and the fourth channel resource set are associated with an absence of any reference signal transmissions.

Aspect 20: The method of any of aspects 1 through 19, wherein the CSI report includes information indicative of a confidence level associated with one or more channel resources of the at least one channel resource pair associated with beam prediction.

Aspect 21: The method of any of aspects 1 through 20, wherein the first channel resource set and the third channel resource set are associated with a first TRP and the second channel resource set and the fourth channel resource set are associated with a second TRP.

Aspect 22: The method of any of aspects 1 through 21, wherein receiving the CSI report setting information comprises receiving the CSI report setting information over one or more messages, each of the one or more messages includes at least a portion of the CSI report setting information.

Aspect 23: A method for wireless communication at a network node, comprising: transmitting CSI report setting information, wherein the CSI report setting information is associated with a first channel resource set for channel measurement and a second channel resource set for channel measurement, and wherein the first channel resource set is associated with a third channel resource set for beam prediction and the second channel resource set is associated with a fourth channel resource set for beam prediction; and receiving a CSI report including information indicative of predicted signal strengths of at least one channel resource pair, wherein each of the at least one channel resource pair includes a respective first channel resource from the third channel resource set and a respective second channel resource from the fourth channel resource set.

Aspect 24: The method of aspect 23, wherein the CSI reporting setting information includes information indicative of the first channel resource set, information indicative of the second channel resource set, information indicative of the third channel resource set, and information indicative of the fourth channel resource set, receiving the CSI report setting information comprises receiving a single CSI report setting message including the CSI report setting information.

Aspect 25: The method of any of aspects 23 through 24, wherein transmitting the CSI report setting information comprises: transmitting a first CSI report setting message that includes information indicative of the first channel resource set and the second channel resource set; and transmitting a second CSI report setting message that includes information indicative of the third channel resource set and the fourth channel resource set.

Aspect 26: The method of any of aspects 23 through 25, wherein the CSI report setting information includes information indicative of a first association between the first channel resource set and the third channel resource set and information indicative of a second association between the second channel resource set and the fourth channel resource set.

Aspect 27: The method of any of aspects 23 through 26, further comprising: transmitting, via a MAC-CE configured to activate the first channel resource set and the second channel resource set, an activation of: a first channel resource set pair that includes the first channel resource set and the third channel resource set, and a second channel resource set pair that includes the second channel resource set and the fourth channel resource set.

Aspect 28: The method of any of aspects 23 through 27, further comprising: transmitting, via a message associated with an aperiodic trigger state associated with the first channel resource set and the second channel resource set, information indicative of: a first channel resource set pair that includes the first channel resource set and the third channel resource set, and a second channel resource set pair that includes the second channel resource set and the fourth channel resource set.

Aspect 29: The method of any of aspects 23 through 28, wherein the CSI report setting information includes information indicative of a plurality of channel resource sets for channel measurement, the plurality of channel resource sets include the first channel resource set and the second channel resource set, and a first subset of the plurality of channel resource sets are associated with a corresponding channel resource set for beam prediction and a second subset of the plurality of channel resource sets are not associated with a corresponding channel resource set for beam prediction.

Aspect 30: The method of any of aspects 23 through 29, further comprising: transmitting, via a MAC-CE that activates the first channel resource set and the second channel resource set or a message associated with an aperiodic trigger state associated with the first channel resource set and the second channel resource set, information indicative of the third channel resource set and the fourth channel resource set, information indicative of a first association between the first channel resource set and the third channel resource set, and information indicative of a second association between the second channel resource set and the fourth channel resource set.

Aspect 31: The method of any of aspects 23 through 30, further comprising: receiving capability information indicative of an upper limit quantity of CSI reports associated with beam prediction, wherein a quantity of the at least one channel resource pair of the one or more channel resource pairs included in the CSI report is associated with the upper limit quantity of CSI reports associated with beam prediction.

Aspect 32: The method of any of aspects 23 through 31, wherein the CSI report setting information includes information indicative of measured signal strengths of one or more second channel resource pairs, each of the one or more second channel resource pairs includes a respective first channel resource from the first channel resource set and a respective second channel resource from the second channel resource set.

Aspect 33: The method of aspect 32, wherein the CSI report includes a first indication of whether a greatest signal strength is associated with a channel measurement or a channel measurement prediction and includes a second indication of which channel resource set the greatest signal strength is associated with, the second indication indicates one of the first channel resource set or the second channel resource set if the first indication indicates that the greatest signal strength is associated with the channel measurement and indicates one of the third channel resource set or the fourth channel resource set if the first indication indicates that the greatest signal strength is associated with the channel measurement prediction.

Aspect 34: The method of aspect 33, wherein the CSI report includes an absolute indication of the greatest signal strength and includes a set of differential indications, relative to the greatest signal strength, of a remaining set of signal strengths of channel resources of the at least one channel resource pair and the one or more second channel resource pairs, the absolute indication includes a first quantity of bits and each of the set of differential indications includes a second quantity of bits less than the first quantity of bits.

Aspect 35: The method of aspect 32, wherein the CSI report includes a first absolute indication of a first signal strength associated with a channel measurement prediction and includes a second absolute indication of a second signal strength associated with a channel measurement, the first signal strength is a greatest signal strength relative to a remaining set of predicted signal strengths of channel resources of the at least one channel resource pair and the second signal strength is a greatest signal strength relative to a remaining set of measured signal strengths of channel resources of the one or more second channel resource pairs.

Aspect 36: The method of aspect 35, wherein the CSI report includes a first set of differential indications, relative to the first signal strength, of the remaining set of predicted signal strengths of channel resources of the at least one channel resource pair and a second set of differential indications, relative to the second signal strength, of the remaining set of measured signal strengths of channel resources of the one or more second channel resource pairs.

Aspect 37: The method of aspect 36, wherein each of the first set of differential indications includes a first quantity of bits and each of the second set of differential indications includes a second quantity of bits different from the first quantity of bits.

Aspect 38: The method of any of aspects 23 through 37, further comprising: transmitting first information associated with a first beam shape correspondence between the first channel resource set and the third channel resource set; and transmitting second information associated with a second beam shape correspondence between the second channel resource set and the fourth channel resource set.

Aspect 39: The method of aspect 38, wherein transmitting the first information and the second information comprises transmitting the first information and the second information via the CSI report setting information, a MAC-CE configured to activate the first channel resource set and the second channel resource set, or a message associated with an aperiodic trigger state associated with the first channel resource set and the second channel resource set.

Aspect 40: The method of any of aspects 23 through 39, wherein the channel resources of the first channel resource set and the second channel resource set are associated with first reference signal transmissions at a first periodicity, second channel resources of the third channel resource set and the fourth channel resource set are associated with second reference signal transmissions at a second periodicity, and the second periodicity is greater than the first periodicity.

Aspect 41: The method of any of aspects 23 through 39, wherein the channel resources of the first channel resource set and the second channel resource set are associated with first reference signal transmissions at a first periodicity, and second channel resources of the third channel resource set and the fourth channel resource set are associated with an absence of any reference signal transmissions.

Aspect 42: The method of any of aspects 23 through 41, wherein the CSI report includes information indicative of a confidence level associated with one or more channel resources of the at least one channel resource pair associated with beam prediction.

Aspect 43: The method of any of aspects 23 through 42, wherein the first channel resource set and the third channel resource set are associated with a first TRP and the second channel resource set and the fourth channel resource set are associated with a second TRP.

Aspect 44: The method of any of aspects 23 through 43, wherein transmitting the CSI report setting information comprises transmitting the CSI report setting information over one or more messages, each of the one or more messages includes at least a portion of the CSI report setting information.

Aspect 45: A network node for wireless communication, comprising a memory; and at least one processor coupled to the memory, wherein the at least one processor is configured to perform a method of any of aspects 1 through 22.

Aspect 46: An apparatus for wireless communication at a network node, comprising at least one means for performing a method of any of aspects 1 through 22.

Aspect 47: A non-transitory computer-readable medium having code for wireless communication stored thereon that, when executed by a network node, causes the network node to perform a method of any of aspects 1 through 22.

Aspect 48: A network node for wireless communication, comprising a memory; and at least one processor coupled to the memory, wherein the at least one processor is configured to perform a method of any of aspects 23 through 44.

Aspect 49: An apparatus for wireless communication at a network node, comprising at least one means for performing a method of any of aspects 23 through 44.

Aspect 50: A non-transitory computer-readable medium having code for wireless communication stored thereon that, when executed by a network node, causes the network node to perform a method of any of aspects 23 through 44.

The methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B. Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the figures, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A network node for wireless communication, comprising:
a memory; and
at least one processor coupled to the memory, wherein the at least one processor is configured to:
receive channel state information report setting information, wherein the channel state information report setting information is associated with a first channel resource set for channel measurement and a second channel resource set for channel measurement, and wherein the first channel resource set is associated with a third channel resource set for beam prediction and the second channel resource set is associated with a fourth channel resource set for beam prediction;
predict, based at least in part on a set of channel measurements associated with channel resources of the first channel resource set and the second channel resource set, a respective signal strength associated with each respective channel resource of one or more channel resource pairs, wherein each of the one or more channel resource pairs includes a respective first channel resource from the third channel resource set and a respective second channel resource from the fourth channel resource set; and
transmit a channel state information report including information indicative of predicted signal strengths of at least one channel resource pair of the one or more channel resource pairs.

2. The network node of claim 1, wherein the channel state information reporting setting information includes information indicative of the first channel resource set, information indicative of the second channel resource set, information indicative of the third channel resource set, and information indicative of the fourth channel resource set, wherein, to receive the channel state information report setting information, the at least one processor is configured to receive a single channel state information report setting message including the channel state information report setting information.

3. The network node of claim 1, wherein, to receive the channel state information report setting information, the at least one processor is configured to:
receive a first channel state information report setting message that includes information indicative of the first channel resource set and the second channel resource set; and
receive a second channel state information report setting message that includes information indicative of the third channel resource set and the fourth channel resource set.

4. The network node of claim 1, wherein the channel state information report setting information includes information indicative of a first association between the first channel resource set and the third channel resource set and information indicative of a second association between the second channel resource set and the fourth channel resource set.

5. The network node of claim 1, wherein the at least one processor is further configured to:
receive, via a medium access control (MAC)-control element (CE) configured to activate the first channel resource set and the second channel resource set, an activation of: a first channel resource set pair that includes the first channel resource set and the third channel resource set, and a second channel resource set pair that includes the second channel resource set and the fourth channel resource set.

6. The network node of claim 1, wherein the at least one processor is further configured to:
receive, via a message associated with an aperiodic trigger state associated with the first channel resource set and the second channel resource set, information indicative of: a first channel resource set pair that includes the first channel resource set and the third channel resource set, and a second channel resource set pair that includes the second channel resource set and the fourth channel resource set.

7. The network node of claim 1, wherein the channel state information report setting information includes information indicative of a plurality of channel resource sets for channel measurement, wherein the plurality of channel resource sets include the first channel resource set and the second channel resource set, and wherein a first subset of the plurality of channel resource sets are associated with a corresponding channel resource set for beam prediction and a second subset of the plurality of channel resource sets are not associated with a corresponding channel resource set for beam prediction.

8. The network node of claim 1, wherein the at least one processor is configured to:
receive, via a medium access control (MAC)-control element (CE) that activates the first channel resource set and the second channel resource set or a message associated with an aperiodic trigger state associated with the first channel resource set and the second channel resource set, information indicative of the third channel resource set and the fourth channel resource set; information indicative of
a first association between the first channel resource set and the third channel resource set, and information indicative of and a second association between the second channel resource set and the fourth channel resource set.

9. The network node of claim 1, wherein the at least one processor is further configured to:
transmit capability information indicative of an upper limit quantity of channel state information reports associated with beam prediction, wherein a quantity of the at least one channel resource pair of the one or more channel resource pairs included in the channel state information report is associated with the upper limit quantity of channel state information reports associated with beam prediction.

10. The network node of claim 1, wherein the channel state information report includes information indicative of measured signal strengths of one or more second channel resource pairs, wherein each of the one or more second channel resource pairs includes a respective first channel resource from the first channel resource set and a respective second channel resource from the second channel resource set.

11. The network node of claim 10, wherein the channel state information report includes a first indication of whether a greatest signal strength is associated with a channel measurement or a channel measurement prediction and includes a second indication of which channel resource set the greatest signal strength is associated with, wherein the second indication indicates one of the first channel resource set or the second channel resource set if the first indication indicates that the greatest signal strength is associated with the channel measurement and indicates one of the third channel resource set or the fourth channel resource set if the first indication indicates that the greatest signal strength is associated with the channel measurement prediction.

12. The network node of claim 11, wherein the channel state information report includes an absolute indication of the greatest signal strength and includes a set of differential indications, relative to the greatest signal strength, of a remaining set of signal strengths of channel resources of the at least one channel resource pair and the one or more second channel resource pairs, wherein the absolute indication includes a first quantity of bits and each of the set of differential indications includes a second quantity of bits less than the first quantity of bits.

13. The network node of claim 10, wherein the channel state information report includes a first absolute indication of a first signal strength associated with a channel measurement prediction and includes a second absolute indication of a second signal strength associated with a channel measurement, wherein the first signal strength is a greatest signal strength relative to a remaining set of predicted signal strengths of channel resources of the at least one channel resource pair and the second signal strength is a greatest signal strength relative to a remaining set of measured signal strengths of channel resources of the one or more second channel resource pairs.

14. The network node of claim 13, wherein the channel state information report includes a first set of differential indications, relative to the first signal strength, of the remaining set of predicted signal strengths of channel resources of the at least one channel resource pair and a second set of differential indications, relative to the second signal strength, of the remaining set of measured signal strengths of channel resources of the one or more second channel resource pairs.

15. The network node of claim 14, wherein each of the first set of differential indications includes a first quantity of bits and each of the second set of differential indications includes a second quantity of bits different from the first quantity of bits.

16. The network node of claim 1, wherein the at least one processor is further configured to:
receive first information associated with a first beam shape correspondence between the first channel resource set and the third channel resource set; and
receive second information associated with a second beam shape correspondence between the second channel resource set and the fourth channel resource set.

17. The network node of claim 16, wherein, to receive the first information and the second information, the at least one processor is configured to receive the first information and the second information via the channel state information report setting information, a medium access control (MAC)-control element (CE) that configured to activate the first channel resource set and the second channel resource set, or a message associated with an aperiodic trigger state associated with the first channel resource set and the second channel resource set.

18. The network node of claim 1, wherein the channel resources of the first channel resource set and the second channel resource set are associated with first reference signal transmissions at a first periodicity, wherein second channel resources of the third channel resource set and the fourth channel resource set are associated with second reference signal transmissions at a second periodicity, and wherein the second periodicity is greater than the first periodicity.

19. The network node of claim 1, wherein the channel resources of the first channel resource set and the second channel resource set are associated with first reference signal transmissions at a first periodicity, and wherein second channel resources of the third channel resource set and the fourth channel resource set are associated with an absence of any reference signal transmissions.

20. The network node of claim 1, wherein the channel state information report includes information indicative of a confidence level associated with one or more channel resources of the at least one channel resource pair associated with beam prediction.

21-30. (canceled)
